(19) United States
(12) Patent Application Publication
(10) Pub. No.: US 2023/0107928 A1
(43) Pub. Date: Apr. 6, 2023

(54) LIDAR ADJUSTMENT METHOD, CIRCUIT, AND APPARATUS, LIDAR, AND STORAGE MEDIUM

(71) Applicant: SUTENG INNOVATION TECHNOLOGY CO., LTD., Shenzhen (CN)

(72) Inventors: Bin TAN, Shenzhen (CN); Shen JIANG, Shenzhen (CN)

(73) Assignee: SUTENG INNOVATION TECHNOLOGY CO., LTD., Shenzhen (CN)

(21) Appl. No.: 18/079,834

(22) Filed: Dec. 12, 2022

Related U.S. Application Data
(63) Continuation-in-part of application No. PCT/CN2020/136617, filed on Dec. 15, 2020.

(30) Foreign Application Priority Data
Dec. 14, 2021 (CN) 2021115262810

(51) Int. Cl. G01S 7/4863; H01L 31/107; H04B 10/80; H01L 27/146; H04B 10/112; G01S 17/14

(52) U.S. Cl. CPC G01S 7/4863; H01L 31/107; H04B 10/80; H01L 27/14643; H04B 10/1123; G01S 17/14

(57) ABSTRACT

This application discloses a LiDAR adjustment method, circuit, and apparatus, a LiDAR, and a storage medium. The method is applied to the LiDAR having a photoelectric sensor, and the method includes: obtaining an operating temperature of the photoelectric sensor; determining a target bias voltage based on the operating temperature, where the target bias voltage is a difference between voltages applied to a cathode and an anode of the photoelectric sensor; and based on the target bias voltage, adjusting the voltages applied to at least one of the anode and the cathode of the photoelectric sensor.

### CROSS-REFERENCE TO RELATED APPLICATION

This application is a continuation-in-part of International Application No. PCT/CN2020/136617, filed Dec. 15, 2020, and also claims the benefit of priority to China Patent Application No. CN 202111526281.0, filed on Dec. 14, 2021, all of which are incorporated herein by reference in their entireties.

### TECHNICAL FIELD

This application relates to the technical field of galvanometer control, and in particular, to a LiDAR adjustment method, circuit, and apparatus, a LiDAR, and a computer storage medium.

### BACKGROUND

In a LiDAR ranging system, conditions of a photoelectric sensor, such as operating temperature and application environment of the photoelectric sensor, seriously affect the receiving capability of the photoelectric sensor, and as a result, the LiDAR has a weaker ranging capability of a short ranging distance, ranging unavailability, or the like in a specific scenario or under some operating conditions.

### SUMMARY

Embodiments of this application provide a LiDAR adjustment method, circuit, and apparatus, a LiDAR, and a storage medium, to compensate for a receiving capability of a photoelectric sensor that is affected by temperature change, thereby improving the adaptability of the LiDAR to various operating environments and a ranging capability of the LiDAR. Technical solutions are as follows.

According to a first aspect, an embodiment of this application provides a LiDAR adjustment method, applied to a LiDAR, where the LiDAR includes a photoelectric sensor and the method includes:

obtaining an operating temperature of the photoelectric sensor;

determining a target bias voltage based on the operating temperature, where the target bias voltage is a difference between voltages applied to a cathode and an anode of the photoelectric sensor; and

based on the target bias voltage, adjusting the voltages applied to at least one of the anode and the cathode of the photoelectric sensor.

According to a second aspect, an embodiment of this application provides a LiDAR adjustment circuit, where the LiDAR adjustment circuit includes: a control sub-circuit, a detection sub-circuit, and a photoelectric sensor;

the detection sub-circuit is connected to the photoelectric sensor and configured to detect an operating temperature of the photoelectric sensor.

the control sub-circuit is connected to the detection sub-circuit and the photoelectric sensor;

the photoelectric sensor is configured to receive an echo signal;

the control sub-circuit is configured to control the detection sub-circuit to detect the operating temperature of the photoelectric sensor; and

the control sub-circuit is further configured to: determine a target bias voltage based on the operating temperature and based on the target bias voltage, adjust a value of a voltage applied to at least one of an anode and a cathode of the photoelectric sensor, and the target bias voltage is a difference between the voltages applied to the anode and the cathode of the photoelectric sensor.

According to a third aspect, an embodiment of this application provides LiDAR, including: a photoelectric sensor, a processor, and a memory;

the processor is connected to the photoelectric sensor and the memory;

the photoelectric sensor is configured to receive an echo signal;

the memory is configured to store executable program code; and

the processor reads the executable program code stored in the memory to run a program corresponding to the executable program code, to perform steps of the method according to the first aspect or any possible implementation of the first aspect of the embodiments of this application.

According to a fourth aspect, an embodiment of this application provides a current limiting protection method, where the method includes:

outputting a drive voltage signal to a current limiting protection circuit;

receiving a first echo signal from a receiving and outputting circuit and parsing the first echo signal to obtain a signal feature value, where the first echo signal is obtained by the receiving and outputting circuit by using the first photoelectric sensor; and

based on the signal feature value, outputting an initial voltage signal to the current limiting protection circuit, where the initial voltage signal is used to instruct the current limiting protection circuit to output a negative bias voltage signal and load the negative bias voltage signal onto an anode of the first photoelectric sensor, to reduce a current value of the first photoelectric sensor.

According to a fifth aspect, an embodiment of this application provides a sensor protection circuit, including: a power supply, a first photoelectric sensor, a receiving and outputting circuit, a current limiting protection circuit, and a controller, where

a first end of the power supply is connected to a cathode of the first photoelectric sensor, a first end of the controller is connected to the current limiting protection circuit, a second end of the controller is connected to the receiving and outputting circuit, a third end of the controller is connected to a second end of the power supply, an anode of the first photoelectric sensor is connected to the receiving and outputting circuit, and the current limiting protection circuit is connected to the anode of the first photoelectric sensor;

the power supply is configured to provide a positive bias voltage signal for the first photoelectric sensor;

the receiving and outputting circuit is configured to receive a first echo signal received by the first photoelectric sensor, and send the first echo signal to the controller;

the controller is configured to receive and parse the first echo signal to obtain a signal feature value, and output an initial voltage signal based on the signal feature value; and

the current limiting protection circuit is configured to obtain a negative bias voltage signal by amplifying the initial voltage signal, and load the negative bias voltage signal to the anode of the first photoelectric sensor, to reduce a current value of the first photoelectric sensor.

According to a sixth aspect, an embodiment of this application provides LiDAR, including a power supply, a current limiting protection circuit, a first photoelectric sensor, a processor, and a memory, where

the processor is connected to the first photoelectric sensor, the power supply, the current limiting protection circuit, and the memory;

the power supply is configured to provide a positive bias voltage signal for the first photoelectric sensor;

the current limiting protection circuit is configured to provide a negative bias voltage signal for the first photoelectric sensor;

the first photoelectric sensor is configured to receive the first echo signal;

the memory is configured to store executable program code; and

the processor reads the executable program code stored in the memory to run a program corresponding to the executable program code, to perform the method according to the fourth aspect or any possible implementation of the fourth aspect of the embodiments of this application.

The beneficial effects provided by the technical solutions of some embodiments of this application are as follows.

Based on the characteristic that the smaller the bias voltage between the two ends of a photoelectric sensor is, the weaker its receiving ability is, through adjusting the voltage applied to the anode and/or cathode of the photoelectric sensor according to the operating temperature of the photoelectric sensor and the preset mapping relationship between the bias voltage between the two ends of the photoelectric sensor and the operating temperature, the bias voltage between the two ends of the photoelectric sensor is adjusted to compensate the influence of temperature change on the receiving ability of the photoelectric sensor, thereby improving the adaptability of the LiDAR to various operating environments and the ranging capability of the LiDAR. The current limiting protection circuit can also be used to limit the operating current of the photoelectric sensor, to prevent an excessively large operating current from generating heat inside the photoelectric sensor, which otherwise causes abnormal operation and even damage to the photoelectric sensor, thereby significantly improving the operation reliability of the photoelectric sensor when receiving high reflected energy and improving the ranging ability of the photoelectric sensor. The foregoing description is merely an overview of the technical solution in this application. For a better understanding of the technical means in this application such that they can be implemented according to the content of this specification, and to make the above and other objectives, features, and advantages of the present invention more obvious and comprehensible, the following describes specific embodiments of the present invention.

### BRIEF DESCRIPTION OF DRAWINGS

To describe the technical solutions in the embodiments of this application more clearly, the following briefly describes the accompanying drawings. Apparently, the accompanying drawings in the following descriptions show merely some embodiments of this application, and a person of ordinary skill in the art may derive other drawings from these accompanying drawings without creative efforts.

FIG. TA is a schematic structural diagram of a LiDAR according to an exemplary embodiment of this application;

FIG. 1B is a schematic diagram of a voltage at two ends of a photoelectric sensor according to an exemplary embodiment of this application;

FIG. 2 is a schematic flowchart of a LiDAR adjustment method according to an exemplary embodiment of this application;

FIG. 3 is a schematic curve diagram of a preset mapping relationship according to an exemplary embodiment of this application;

FIG. 4 is a schematic structural diagram of another LiDAR according to an exemplary embodiment of this application;

FIG. 5 is a schematic flowchart of another LiDAR adjustment method according to an exemplary embodiment of this application;

FIG. 6A is a schematic diagram of a first preset linear relationship according to an exemplary embodiment of this application;

FIG. 6B is a schematic diagram of a pulse wideband modulation signal according to an exemplary embodiment of this application;

FIG. 6C is a schematic diagram of a voltage at two ends of another photoelectric sensor according to an exemplary embodiment of this application;

FIG. 7 is a schematic flowchart of another LiDAR adjustment method according to an exemplary embodiment of this application;

FIG. 8A is a schematic diagram of a second preset linear relationship according to an exemplary embodiment of this application;

FIG. 8B is a schematic diagram of another pulse wideband modulation signal according to an exemplary embodiment of this application;

FIG. 8C is a schematic diagram of a voltage at two ends of another photoelectric sensor according to an exemplary embodiment of this application;

FIG. 9 is a schematic flowchart of another LiDAR adjustment method according to an exemplary embodiment of this application;

FIG. 10 is a schematic diagram of a voltage change of an anode and a cathode of a photoelectric sensor according to an exemplary embodiment of this application;

FIG. 11 is a schematic structural diagram of another LiDAR according to an exemplary embodiment of this application;

FIG. 12 is a schematic structural diagram of another LiDAR according to an exemplary embodiment of this application;

FIG. 13 is a schematic flowchart of another LiDAR adjustment method according to an exemplary embodiment of this application;

FIG. 14 is a schematic flowchart of another LiDAR adjustment method according to an exemplary embodiment of this application;

FIG. 15 is a schematic diagram of a voltage change of a cathode of a photoelectric sensor according to an exemplary embodiment of this application;

FIG. 16 is a schematic structural diagram of a LiDAR adjustment circuit according to an exemplary embodiment of this application;

FIG. 17 is a schematic structural diagram of a LiDAR adjustment apparatus according to an exemplary embodiment of this application;

FIG. 18 is a schematic structural diagram of another LiDAR according to an exemplary embodiment of this application;

FIG. 19 is a schematic structural diagram of a sensor protection circuit according to an exemplary embodiment of this application;

FIG. 20 is a schematic structural diagram of another sensor protection circuit according to an exemplary embodiment of this application;

FIG. 21 is a schematic structural diagram of another sensor protection circuit according to an exemplary embodiment of this application;

FIG. 22 is a schematic flowchart of a current limiting protection method according to an exemplary embodiment of this application; and

FIG. 23 is a schematic structural diagram of a current limiting protection apparatus according to an exemplary embodiment of this application.

### DETAILED DESCRIPTION

To make features and advantages of this application clearer, the following describes the technical solutions in the embodiments of this application with reference to the accompanying drawings. Apparently, the described embodiments are some but not all the embodiments of this application. Based on the embodiments of this application, all other embodiments obtained by the person skilled in the art without inventive labor shall fall within the protection scope of this application.

Terms “first,” “second,” “third,” and the like in this specification and claims of this application and the foregoing drawings are used to distinguish different objects, instead of describing a specific sequence. In addition, terms such as “include,” “have,” and any variants thereof are intended to cover non-exclusive inclusion. For example, a process, a method, a system, a product, or a device that includes a series of steps or units is not limited to the listed steps or units, but further includes an unlisted step or unit, or further includes another inherent step or unit of the process, the method, the product, or the device.

FIG. TA exemplarily shows a schematic structural diagram of a LiDAR according to an embodiment of this application. As shown in FIG. TA, the LiDAR may include: a laser emitter 110, a photoelectric sensor 120, a power supply 130, a temperature sensor 140, and a controller 150.

The laser emitter 110 may be configured to emit a laser beam.

The photoelectric sensor 120 may be a diode or the like, and is configured to receive an echo signal generated by the laser beam. In this application, the photoelectric sensor 120 may be considered as a single-photon avalanche photodiode used during laser communication, which uses an avalanche multiplication effect of charge carriers to amplify a photoelectric signal to improve detection sensitivity. For example, models of the photoelectric sensor 120 include, but are not limited to, C30659-900-R5BH, C30659-1550-R08BH, and C30919E. Taking a highly sensitive SiPM (silicon photomultiplier) as an example of the photoelectric sensor 120, the SiPM includes a plurality of micro-units connected in parallel, and each micro-unit includes a single-photon avalanche diode (SPAD) and a quenching resistor. When a reverse bias voltage is applied to the silicon photomultiplier (the reverse bias voltage is generated by both a positive bias voltage signal and a negative bias voltage signal, which is tens of volts), a SPAD depletion layer of each micro-unit has an electric field with extremely high electric intensity. If photons are incident from the outside in this case, Compton scattering occurs between the photons and an electron-hole pair in a SPAD semiconductor to generate electrons or holes. The energy-rich electrons and holes are then accelerated in the electric field and excited, to generate a large number of secondary electrons and holes, that is, an avalanche effect occurs. In this case, a current output by each micro-unit is suddenly increased, a voltage on the quenching resistor is also increased, and the electric field in the SPAD is weakened instantaneously. That is, the avalanche stops after the SPAD outputs an instantaneous current pulse. Therefore, an SiPM array can serve as a photoelectric sensor to convert an optical signal into a current signal.

The power supply 130 can be configured to supply power to the photoelectric sensor 120 and apply a bias voltage to both ends of the photoelectric sensor 120; and the power supply 130 can include a first end and a second end. The first end of the anode of the photoelectric sensor 120 can be a negative power supply, and the second end of the cathode of the photoelectric sensor 120 may be a positive power supply, and so on, which is not limited in this application. Further, the first end of the anode of the photoelectric sensor 120 may be a ground terminal, and the second end of the cathode of the photoelectric sensor 120 may be the positive power supply. The power supply 101 can be considered as a component for controlling the loading of a positive bias voltage signal to the cathode of the photoelectric sensor 120 based on a preset rule. In some embodiments, the power supply 130 is a high-voltage pulse power supply, which can be considered as a high-voltage power supply that is obtained by adding a switch circuit based on a high-voltage direct-current power supply, so that output pulse amplitude, pulse width, and pulse frequency are adjustable, and the number of output pulses is settable.

The temperature sensor 140 is connected to the photoelectric sensor 120 and is configured to detect the operating temperature of the photoelectric sensor 120 in real time.

The controller 150 is electrically connected to the laser emitter 110 and the temperature sensor 140, and is configured to: control the laser emitter 110 to emit a laser beam, control the temperature sensor 140 to detect the operating temperature of the photoelectric sensor 120 based on a preset time interval, and receive the operating temperature output by the temperature sensor 140. The foregoing preset time interval may be 2 ms, 3 s, or the like, which is not limited in this application.

The controller 150 is also configured to: determine the target bias voltage corresponding to the operating temperature of the photoelectric sensor 120 based on a preset mapping relationship, and based on the foregoing target bias voltage, adjust the voltage applied to at least one of the anode and the cathode of the photoelectric sensor 120, and the foregoing preset mapping relationship includes a plurality of temperatures and bias voltages respectively corresponding to different temperatures.

The controller 150 is configured to: based on the target bias voltage corresponding to the operating temperature of the photoelectric sensor 120, determine a duty ratio of a pulse width modulation signal applied to at least one of the first end and the second end, and output the pulse width modulation signal to at least one of the first end and the second end based on the foregoing duty ratio, to provide the voltage for at least one of the cathode and the anode of the photoelectric sensor 120.

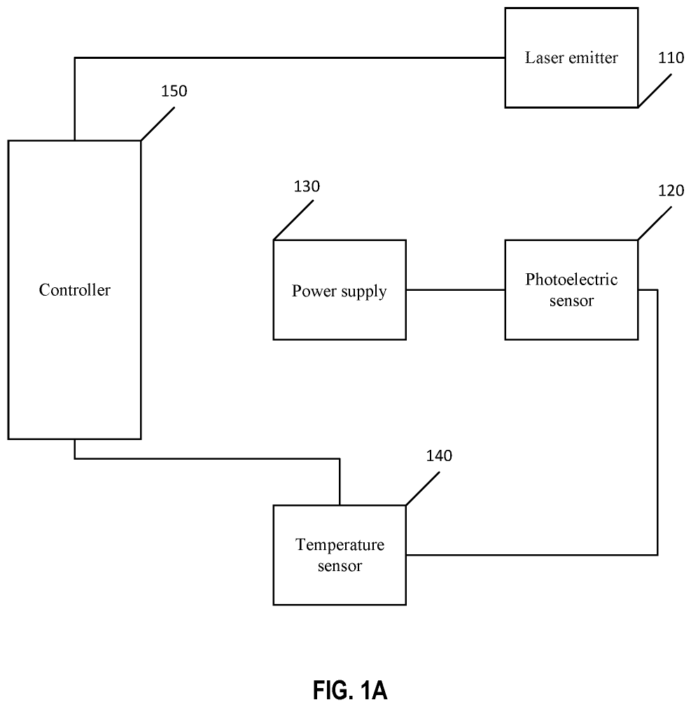

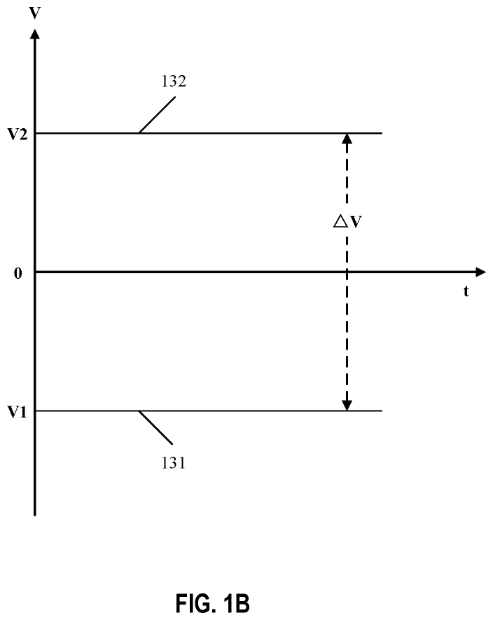

Exemplarily, the second end may provide the anode of the photoelectric sensor 120 with a voltage 131 with a value of V1 shown in FIG. 1B, and the first end may provide the cathode of the photoelectric sensor 120 with a voltage 132 with a value of V2 shown in FIG. 1B. In this case, however, an operating condition and an application environment of the photoelectric sensor 120 change, and a bias voltage ΔV between the two ends of the photoelectric sensor 120 is V2−V1 (V2>V1).

In some embodiments, the controller 150 may include a processing unit and a collection unit; the foregoing collection unit is connected to the temperature sensor 140 and the photoelectric sensor 120, and is configured to collect data such as the operating temperature of the photoelectric sensor 120 that is detected by the temperature sensor 140 and an echo signal generated by a laser beam received by the photoelectric sensor 120; and the foregoing processing unit may process the data received by the foregoing collection unit.

The controller 150 may be implemented by using an FPGA (field-programmable gate array) or an ASIC (application specific integrated circuit). The field-programmable gate array is a program-driven logic device, similar to a microprocessor, and has a control program stored in a memory. After power-on, the program is automatically loaded into a chip for execution. The field-programmable gate array usually includes two programmable modules and storage SRAMs. CLB is a programmable logic block, a core component of the field-programmable gate array, and a basic unit for implementing a logic function. The CLB mainly includes a digital logic circuit such as a logic function generator, flip-flop, and a data selector. In an ASIC chip technology, all interface modules (including a control module) are connected to a matrix backplane, and communication between a plurality of modules can be performed simultaneously through direct forwarding between ASIC chips. A cache of each module only processes input and output queues on the module, and therefore, the performance requirement for a memory chip is much lower than that in a shared memory method. In conclusion, a switching matrix is characterized by high access efficiency, simultaneous multi-point access availability, extra-high bandwidth feasibility, and performance expansion readiness, and is free from limitations of CPU, bus, and memory technologies.

A receiving capability of the photoelectric sensor 120 is directly related to the bias voltage between the two ends of the photoelectric sensor 120, and when the bias voltage remains unchanged, the receiving capability of the photoelectric sensor 120 varies with the operating temperature. In a ranging process of the LiDAR, the operating temperature of the photoelectric sensor 120 is inconstant. The change in the operating temperature seriously affects the receiving capability of the photoelectric sensor 120, and as a result, the LiDAR has a weaker ranging capability of a short ranging distance, ranging unavailability, or the like in a specific scenario or under some operating conditions. Based on a mapping relationship between the bias voltage between the two ends of the photoelectric sensor 120 and the operating temperature, the voltage applied to at least one of the anode and the cathode of the photoelectric sensor is adjusted, thereby adjusting the bias voltage of the photoelectric sensor 120 to compensate for the influence of temperature change on the receiving capability of the photoelectric sensor 120, and improving the adaptability of the LiDAR to various operating environments and the ranging capability of the LiDAR.

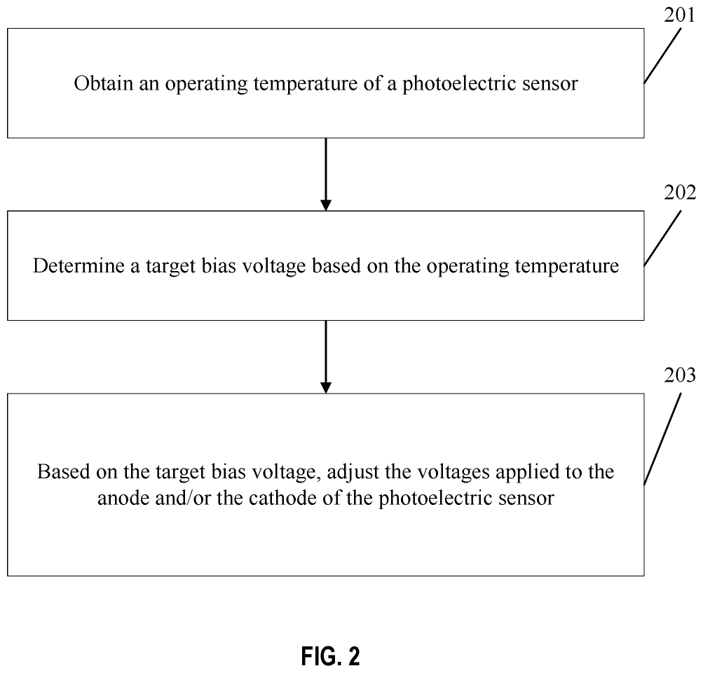

Then, with reference to FIG. 1A and FIG. 1B, a LiDAR adjustment method provided in an exemplary embodiment of this application is introduced. FIG. 2 is a schematic flowchart of a LiDAR adjustment method according to an exemplary embodiment of this application. As shown in FIG. 2, the LiDAR adjustment method includes the following steps.

Step 201: Obtain an operating temperature of a photoelectric sensor.

In the ranging process of the LiDAR, the temperature sensor 140 may be controlled to detect the operating temperature of the photoelectric sensor at a preset time interval, and obtain the operating temperature of the foregoing photoelectric sensor. The preset time interval may be 2 ms, 3 s, or the like, which is not limited in this application.

Step 202: Determine a target bias voltage based on the operating temperature.

After the operating temperature of the photoelectric sensor is obtained, the target bias voltage corresponding to the operating temperature may be determined by querying the preset mapping relationship. The foregoing preset mapping relationship includes a plurality of temperatures and bias voltages corresponding to different temperatures respectively. The foregoing preset mapping relationship represents a relationship between the bias voltage and the operating temperature of the photoelectric sensor. The foregoing target bias voltage is the difference between the voltages applied to the cathode and the anode of the photoelectric sensor.

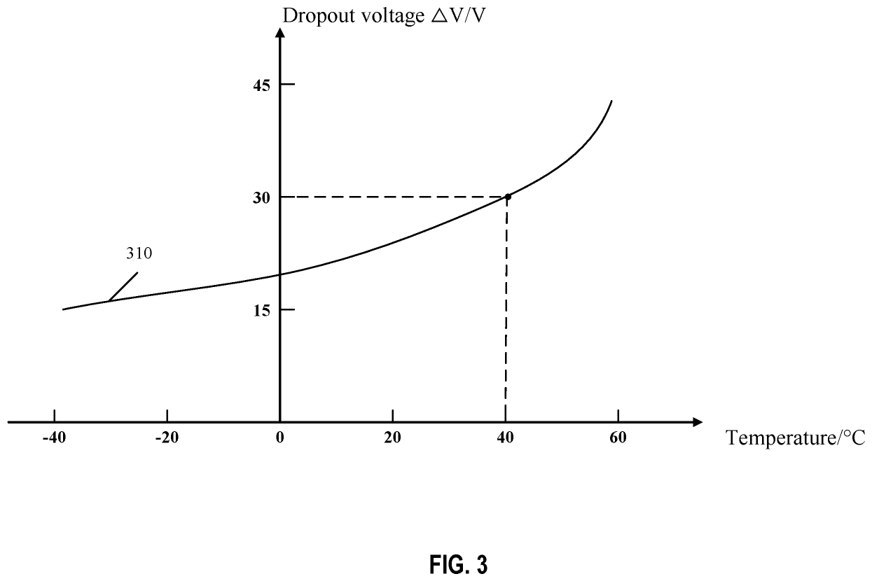

Exemplarily, FIG. 3 is a schematic curve diagram of a preset mapping relationship according to an exemplary embodiment of this application. As shown in FIG. 3, when the obtained operating temperature of the photoelectric sensor is 40° C., the bias voltage ΔV corresponding to the foregoing operating temperature can be determined to be 30 V by querying a curve 310 of the preset mapping relationship shown in FIG. 3. In other words, when the operating temperature of the photoelectric sensor is 40° C., the target bias voltage corresponding to both ends of the photoelectric sensor should be 30 V. That is, if the operating temperature of the photoelectric sensor is 40° C., the photoelectric sensor is in an optimal operating status only when the bias voltage ΔV between the two ends of the photoelectric sensor is 30 V, to ensure the ranging capability of the LiDAR.

Step 203: Based on the target bias voltage, adjust the voltages applied to at least one of the anode and the cathode of the photoelectric sensor.

After the target bias voltage corresponding to the operating temperature of the photoelectric sensor is determined, a duty ratio of the pulse width modulation signal applied to the power supply 130 may be determined based on the foregoing target bias voltage.

Based on the modulation signal with the foregoing duty ratio, the power supply 130 is controlled to output the target voltage to at least one of the anode and the cathode of the photoelectric sensor. The foregoing modulation signal may be the pulse width modulation signal. In other words, the duty ratio of the pulse width modulation signal is adjusted, to control at least one of a value of the voltage provided by the second end for the anode of the photoelectric sensor and a value of the voltage provided by the first end for the cathode of the photoelectric sensor, so that the bias voltage between the two ends of the photoelectric sensor is the target bias voltage.

In this embodiment of this application, based on the operating temperature of the photoelectric sensor and a preset mapping relationship between the bias voltage between the two ends of the photoelectric sensor and the operating temperature, the voltage applied to at least one of the anode and the cathode of the photoelectric sensor is adjusted, thereby adjusting the bias voltage between the two ends of the photoelectric sensor to compensate for the influence of temperature change on the receiving capability of the photoelectric sensor and improving the adaptability of the LiDAR when the operating temperature changes slowly and the ranging capability of the LiDAR.

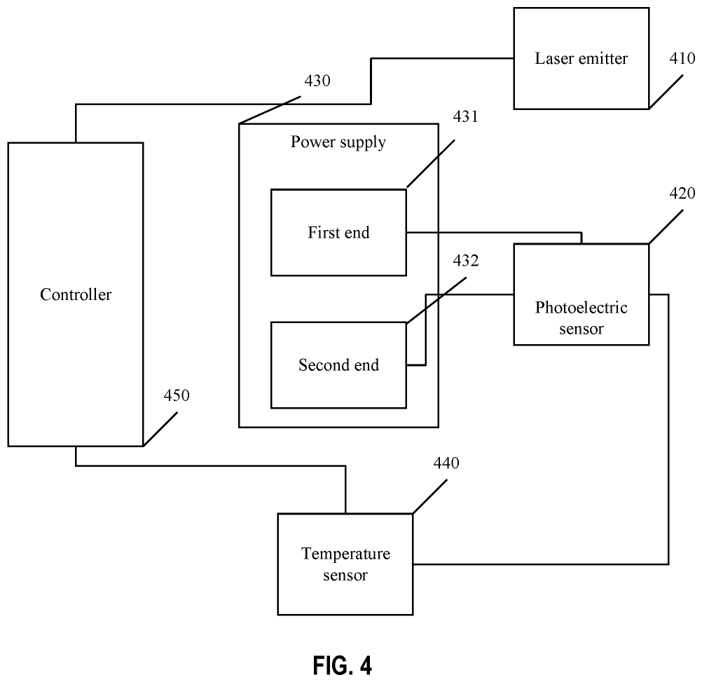

FIG. 4 is a schematic structural diagram of another LiDAR according to an exemplary embodiment of this application. As shown in FIG. 4, the LiDAR may include: a laser emitter 410, a photoelectric sensor 420, a power supply 430, a temperature sensor 440, and a controller 450.

The laser emitter 410 is configured to emit a laser beam.

The photoelectric sensor 420 is configured to receive an echo signal generated by the foregoing laser beam.

The power supply 430 may include a first end 431 and a second end 432; and the first end 431 may be an adjustable power supply, a digital-to-analog converter (DAC), or a high-speed high-voltage operation amplifier, and is configured to provide a voltage for the anode of the photoelectric sensor 420. The foregoing adjustable power supply adjusts a voltage and a current in a wide range by broadening a voltage and current of a switch-mode power supply. The foregoing DAC can convert a binary digital parameter into a direct-current voltage; the foregoing high-speed high-voltage operation amplifier is a circuit unit with a high level of magnification; and the foregoing second end 432 may be the adjustable power supply, the DAC, or the high-speed high-voltage operation amplifier, and is configured to provide a voltage for the cathode of the photoelectric sensor.

The temperature sensor 440 is connected to the photoelectric sensor 420 and is configured to detect the operating temperature of the photoelectric sensor 420.

The controller 450 is connected to the laser emitter 410 and the temperature sensor 440, and is configured to control the laser emitter 410 to emit a laser beam and receive the operating temperature output by the temperature sensor 440.

The controller 450 is further configured to: determine a target bias voltage based on the operating temperature and based on the target bias voltage, adjust a value of a voltage applied to at least one of an anode and a cathode of the photoelectric sensor, and the target bias voltage is a difference between the voltages applied to the anode and the cathode of the photoelectric sensor.

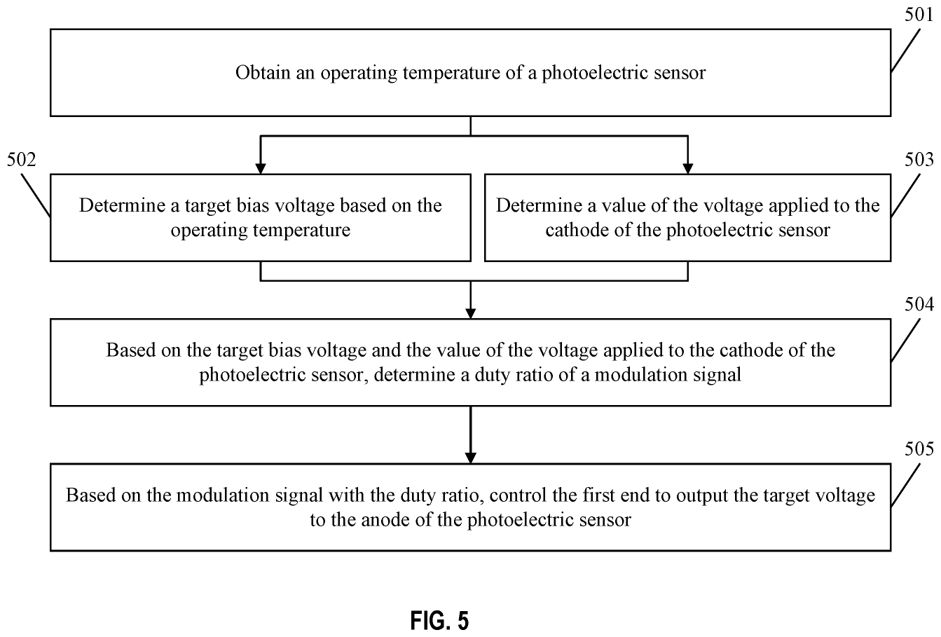

Then, with reference to FIG. 4, another LiDAR adjustment method provided in an exemplary embodiment of this application is introduced. When the controller 450 in FIG. 4 is configured to control a value of the voltage applied to the anode of the photoelectric sensor 420, FIG. 5 is referenced. FIG. 5 is a schematic flowchart of a LiDAR adjustment method according to an exemplary embodiment of this application. As shown in FIG. 5, the LiDAR adjustment method includes the following steps.

Step 501: Obtain an operating temperature of a photoelectric sensor.

Step 501 is consistent with step 201. Details are not described herein again.

Step 502: Determine a target bias voltage based on the operating temperature.

Step 502 is consistent with step 202. Details are not described herein again.

Step 503: Determine a value of the voltage applied to the cathode of the photoelectric sensor.

If the LiDAR has the structure shown in FIG. 4, a value of the voltage output by the second end 432 can be directly used as a value of the voltage applied to the cathode of the photoelectric sensor.

Exemplarily, if the value of the voltage output by the second end 432 of the LiDAR shown in FIG. 4 is 30 V, the value of the voltage applied to the cathode of the photoelectric sensor can be determined to be 30 V.

Step 504: Based on the target bias voltage and the value of the voltage applied to the cathode of the photoelectric sensor, determine a duty ratio of a modulation signal.

The foregoing modulation signal may be a pulse width modulation signal, and all the following exemplary embodiments are described by using the pulse wideband modulation signal as the modulation signal. The value of the voltage that needs to be applied to the anode of the photoelectric sensor can be determined based on the foregoing target bias voltage and the value of the voltage applied to the cathode of the photoelectric sensor, so that a duty ratio of the pulse width modulation signal that needs to be applied to the first end 431 can be determined based on the first preset linear relationship. The foregoing first preset linear relationship is used to represent a relationship between the value of the voltage output by the second end and the duty ratio of the pulse width modulation signal. The duty ratio of the foregoing pulse width modulation signal is a percentage of time when the pulse width modulation signal is at a high level in the whole cycle.

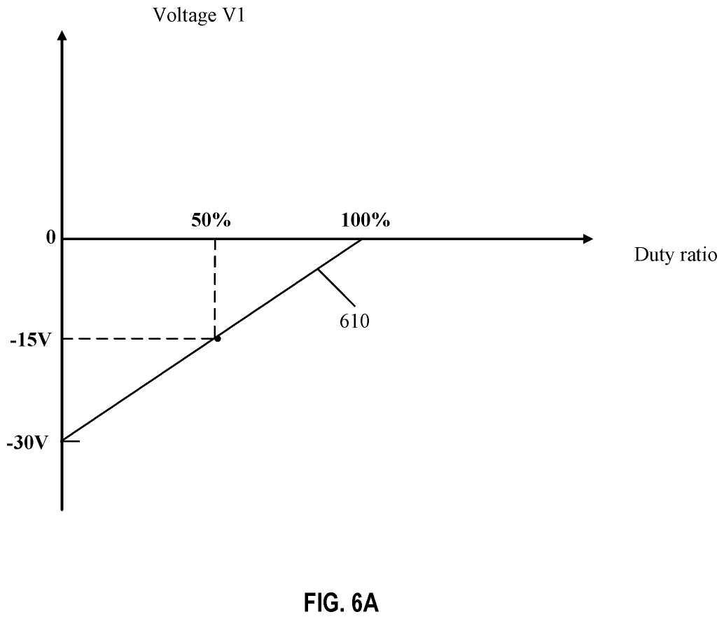

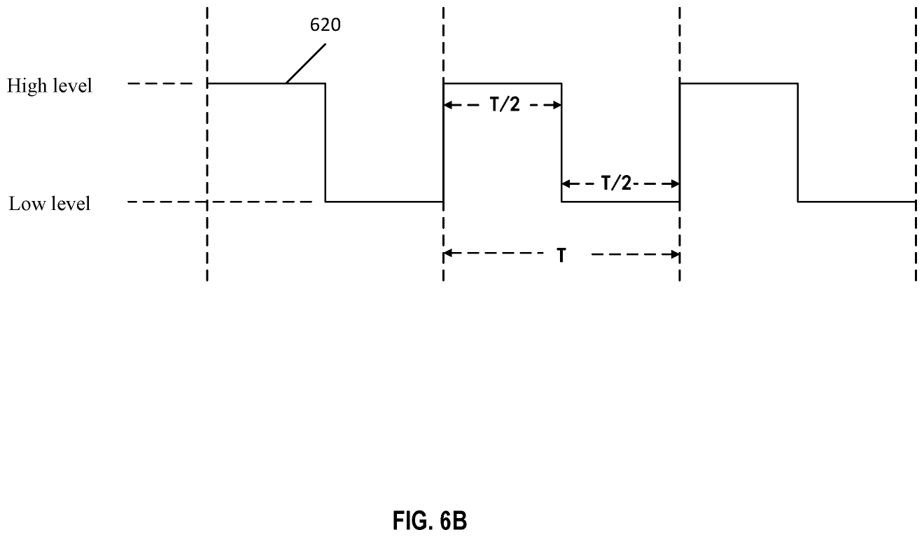

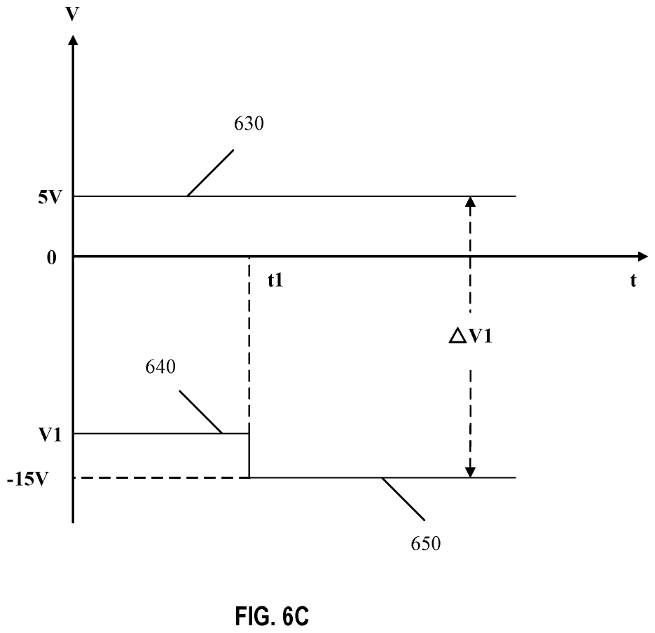

Exemplarily, if the foregoing target bias voltage ΔV is 20 V and a value V2 of the voltage applied to the cathode of the photoelectric sensor is 5 V, it can be determined that the value V1 of the voltage that needs to be applied to the anode of the photoelectric sensor satisfies that V1=V2−ΔV=−15 V. Therefore, based on the first preset linear relationship 610 shown in FIG. 6A, it can be detected that when the value of the voltage output by the first end 431 is −15 V, that is, the value V1 of the voltage applied to the anode of the photoelectric sensor is −15 V, the duty ratio of the corresponding pulse width modulation signal that needs to be applied to the first end 431 is 50%. In this case, the pulse width modulation signal output by the controller 450 is shown in FIG. 6B. It could be learned from FIG. 6B that the time when the pulse width modulation signal 620 is at the high level makes up 50% of the whole cycle T, that is, T/2.

Step 505: Based on the modulation signal with the duty ratio, control the first end to output the target voltage to the anode of the photoelectric sensor.

After the controller 450 determines the duty ratio of the pulse width modulation signal applied to the first end 431, the controller 450 can output the pulse width modulation signal with the foregoing duty ratio to the first end 431, thus controlling the value of the voltage output by the first end 431 to be the target voltage, so that the bias voltage between the two ends of the photoelectric sensor is the target bias voltage.

Exemplarily, if an operating temperature of the photoelectric sensor that is obtained at a moment t1 is greater than an operating temperature of the photoelectric sensor before the moment t1, and the target bias voltage ΔV1 determined based on the operating temperature of the photoelectric sensor at the moment t1 is 20 V, as shown in FIG. 6C, a voltage 630 applied to the cathode of the photoelectric sensor is 5 V, the duty ratio, determined based on the first preset linear relationship 610 shown in FIG. 6A, of the pulse width modulation signal applied to the first end 431 is 50%, and therefore, the controller 450 can output the pulse width modulation signal 620 with the duty ratio of 50% shown in FIG. 6B to the first end 431 at the moment t1, thus controlling the voltage output by the first end 431 shown in FIG. 6C to jump from voltage 640 with a value of V1 shown in FIG. 6C to target voltage 650 with the value of −15 V, so that the bias voltage between the two ends of the photoelectric sensor reaches the target bias voltage ΔV1.

In this embodiment of this application, when the impact of temperature on the receiving capability of the photoelectric sensor can be eliminated, the target bias voltage between the two ends of the photoelectric sensor is determined based on the operating temperature of the photoelectric sensor, and then, duty ratios of high and low levels of the pulse width modulation signal are adjusted based on the target bias voltage between the two ends of the photoelectric sensor and the value of the voltage applied to the cathode of the photoelectric sensor, thus controlling the first end 431 to output a different voltage, that is, controlling the voltage applied to the anode of the photoelectric sensor, thereby compensating for the receiving capability of the photoelectric sensor affected by the temperature, ensuring the ranging performance of the LiDAR, and improving user experience.

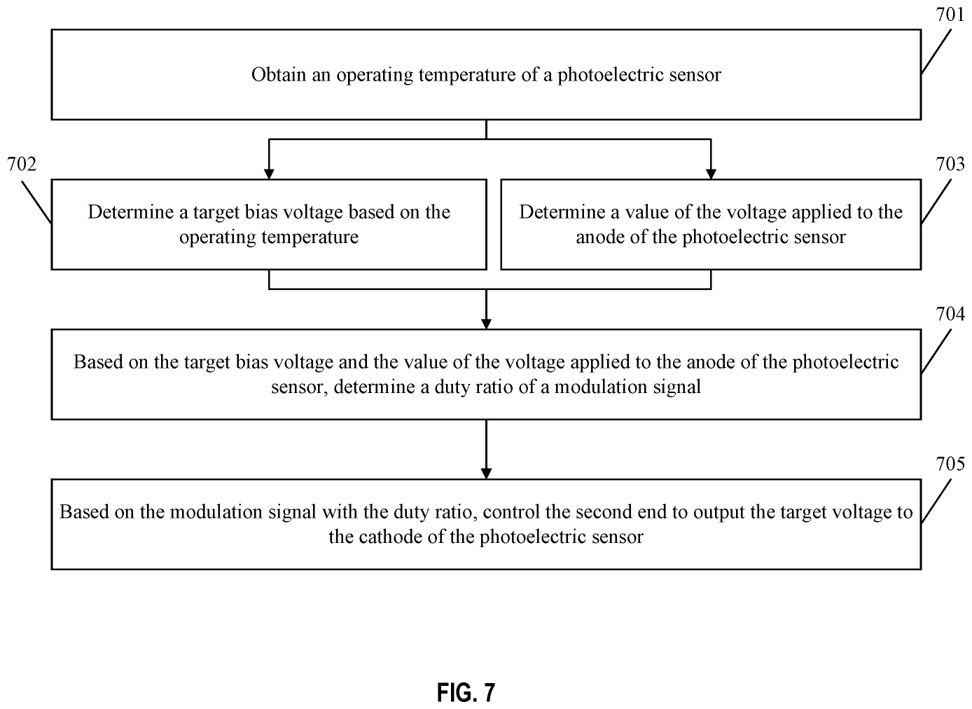

Then, with reference to FIG. 4 and FIG. 7, another LiDAR adjustment method provided in an exemplary embodiment of this application is introduced. When the controller 450 in FIG. 4 is configured to control a value of the voltage applied to the cathode of the photoelectric sensor 420, FIG. 7 is referenced. FIG. 7 is a schematic flowchart of another LiDAR adjustment method. As shown in FIG. 7, the LiDAR adjustment method includes the following steps.

Step 701: Obtain an operating temperature of a photoelectric sensor.

Step 701 is consistent with step 201. Details are not described herein again.

Step 702: Determine a target bias voltage based on the operating temperature.

Step 702 is consistent with step 202. Details are not described herein again.

Step 703: Determine a value of the voltage applied to the anode of the photoelectric sensor.

For the LiDAR structure shown in FIG. 4, a value of the voltage output by the first end 431 can be directly used as a value of the voltage applied to the anode of the photoelectric sensor.

Exemplarily, if the value of the voltage output by the first end 431 of the LiDAR shown in FIG. 4 is −30 V, the value of the voltage applied to the anode of the photoelectric sensor can be directly determined to be −30 V.

Step 704: Based on the target bias voltage and the value of the voltage applied to the anode of the photoelectric sensor, determine a duty ratio of a modulation signal.

The foregoing modulation signal may be a pulse width modulation signal, and all the following embodiments are described by using the pulse wideband modulation signal as the modulation signal. The LiDAR includes a second end, and the second end may be the second end 432 shown in FIG. 4. The value of the voltage that needs to be applied to the cathode of the photoelectric sensor can be determined based on the foregoing target bias voltage and the value of the voltage applied to the anode of the photoelectric sensor, so that a duty ratio of the pulse width modulation signal that needs to be applied to the second end 432 can be determined based on the second preset linear relationship. The foregoing second preset linear relationship is used to represent a relationship between the value of the voltage output by the first end and the duty ratio of the pulse width modulation signal. The duty ratio of the foregoing pulse width modulation signal is a percentage of time when the pulse width modulation signal is at a high level in the whole cycle.

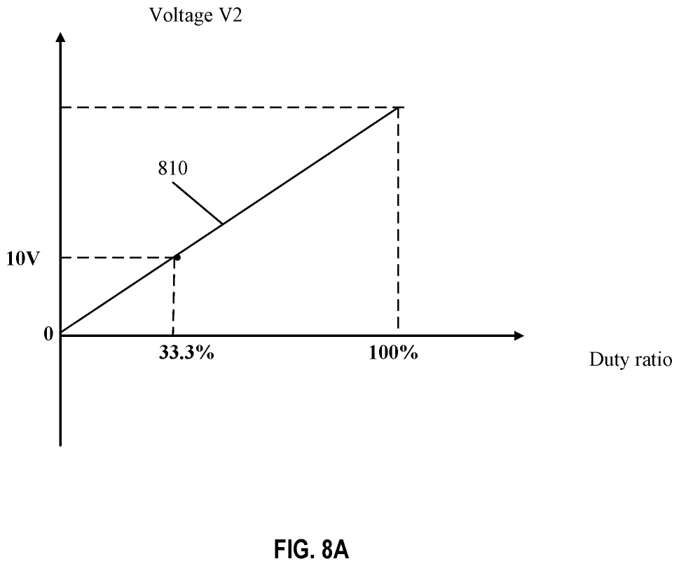

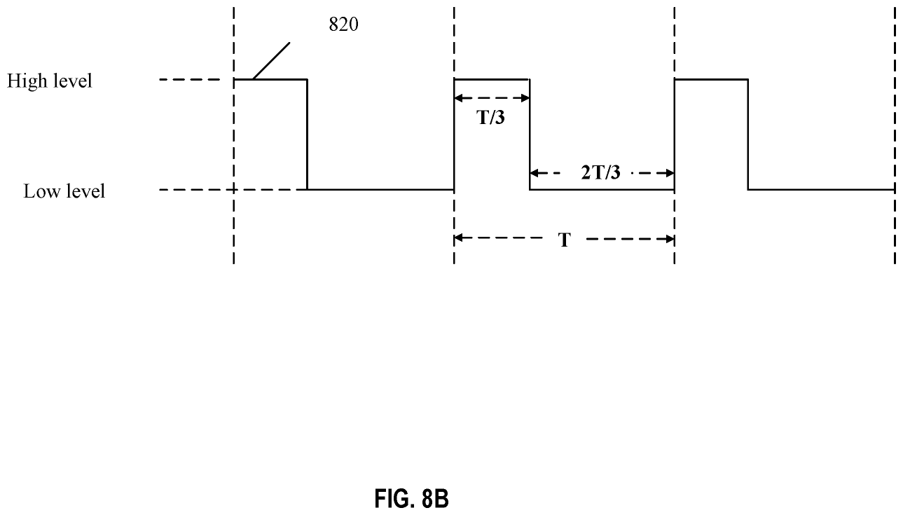

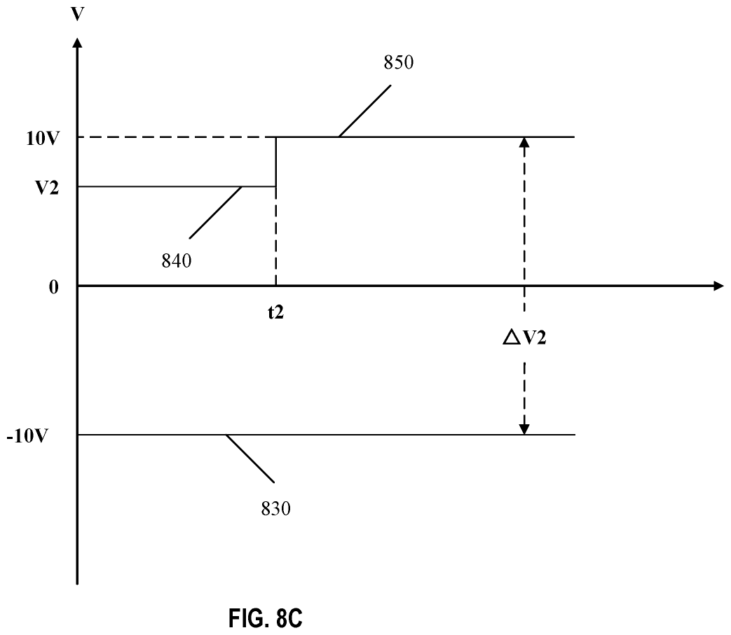

Exemplarily, if the foregoing target bias voltage ΔV is 20 V and a value V1 of the voltage applied to the anode of the photoelectric sensor is −10 V, it can be determined that the value V2 of the voltage that needs to be applied to the cathode of the photoelectric sensor satisfies that V2=ΔV+V1=10 V. Therefore, based on the second preset linear relationship 810 shown in FIG. 8A, it can be detected that when the value of the voltage output by the second end 432 is 10 V, that is, the value V2 of the voltage applied to the cathode of the photoelectric sensor is 10 V, the duty ratio of the corresponding pulse width modulation signal that needs to be applied to the second end 432 is 33.3%. In this case, the pulse width modulation signal output by the controller 450 is shown in FIG. 8B. It could be learned from FIG. 8B that the time when the pulse width modulation signal 820 is at the high level makes up 33.3% of the whole cycle T, that is, T/3.

Step 705: Based on the modulation signal with the duty ratio, control the second end to output the target voltage to the cathode of the photoelectric sensor.

After the controller 450 determines the duty ratio of the pulse width modulation signal applied to the second end 432, the controller 450 can output the pulse width modulation signal with the foregoing duty ratio to the second end 432, thus controlling the value of the voltage output by the second end 432 to be the target voltage, so that the bias voltage between the two ends of the photoelectric sensor is the target bias voltage.

Exemplarily, if an operating temperature of the photoelectric sensor obtained at a moment t2 is greater than an operating temperature of the photoelectric sensor before the moment t2, and the target bias voltage ΔV2 determined based on the operating temperature of the photoelectric sensor at the moment t2 is 20 V, as shown in FIG. 8C, a voltage 830 applied to the anode of the photoelectric sensor is −10 V, the duty ratio, determined based on the second preset linear relationship 810 shown in FIG. 8A, of the pulse width modulation signal applied to the second end 432 is 33.3%, and therefore, the controller 450 can output the pulse width modulation signal 820 with the duty ratio of 33.3% shown in FIG. 8B to the second end 432 at the moment t2, thus controlling the voltage output by the second end 432 shown in FIG. 8C to jump from voltage 840 with a value of V2 shown in FIG. 8C to target voltage 850 with the value of 10 V, so that the bias voltage between the two ends of the photoelectric sensor reaches the target bias voltage ΔV2.

In this embodiment of this application, when the impact of temperature on the receiving capability of the photoelectric sensor can be eliminated, the target bias voltage between the two ends of the photoelectric sensor is determined based on the operating temperature of the photoelectric sensor, and then, duty ratios of high and low levels of the pulse width modulation signal are adjusted based on the target bias voltage between the two ends of the photoelectric sensor and the value of the voltage applied to the anode of the photoelectric sensor, thus controlling the first end to output a different voltage, that is, controlling the voltage applied to the cathode of the photoelectric sensor, thereby compensating for the receiving capability of the photoelectric sensor affected by the temperature, ensuring the ranging performance of the LiDAR, and improving user experience.

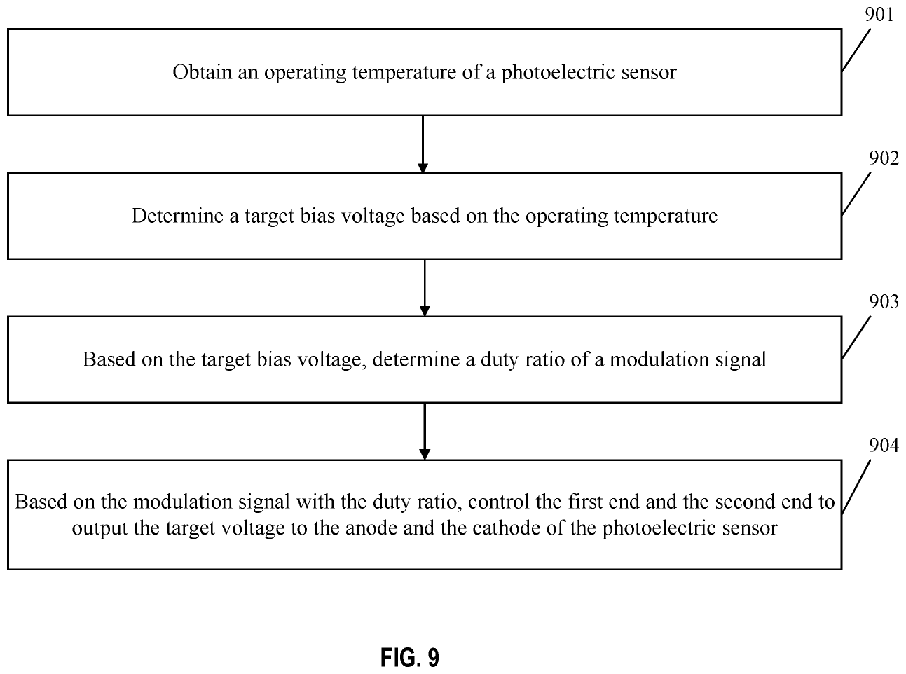

Then, with reference to FIG. 4 and FIG. 9, another LiDAR adjustment method provided in an exemplary embodiment of this application is introduced. When the controller 450 in FIG. 4 is configured to control both values of the voltages applied to the anode and the cathode of the photoelectric sensor 420, FIG. 9 is referenced. FIG. 9 is a schematic flowchart of another LiDAR adjustment method. As shown in FIG. 9, the LiDAR adjustment method includes the following steps.

Step 901: Obtain an operating temperature of a photoelectric sensor.

Step 901 is consistent with step 201. Details are not described herein again.

Step 902: Determine a target bias voltage based on the operating temperature.

Step 902 is consistent with step 202. Details are not described herein again.

Step 903: Based on the target bias voltage, determine a duty ratio of a modulation signal.

The values of the voltages that need to be applied to the anode and the cathode of the photoelectric sensor can be determined separately based on the foregoing target bias voltage and the preset ratio, so that duty ratios of pulse width modulation signals that need to be applied to the first end 431 and the second end 432 can be determined separately based on the first preset linear relationship and the second preset linear relationship. The foregoing preset ratio is used to represent a ratio of the value of the voltage that needs to be applied to the anode of the photoelectric sensor to the value of voltage that needs to be applied to the cathode. The foregoing preset ratio is less than 1, and may be −1:1, 1:2, −1:3, or the like, which is not limited in this application. The foregoing first preset linear relationship is used to represent a relationship between the value of the voltage output by the second end and the duty ratio of the pulse width modulation signal. The foregoing second preset linear relationship is used to represent a relationship between the value of the voltage output by the first end and the duty ratio of the pulse width modulation signal. The duty ratio of the foregoing pulse width modulation signal is a percentage of time when the pulse width modulation signal is at a high level in the whole cycle.

Exemplarily, if the foregoing target bias voltage ΔV is 25 V and a preset ratio between the values of the voltages that need to be applied to the anode and the cathode of the photoelectric sensor is −3:2, it can be determined that the value V1 of the voltage that needs to be applied to the anode of the photoelectric sensor is −15 V, the value V2 of the voltage that needs to be applied to the cathode of the photoelectric sensor is 10 V. Therefore, based on the first preset linear relationship 610 shown in FIG. 6A, it can be detected that when the value of the voltage output by the first end 431 is −15 V, that is, the value V1 of the voltage applied to the anode of the photoelectric sensor is −15 V, the duty ratio of the corresponding pulse width modulation signal that needs to be applied to the first end 431 is 50%; and based on the second preset linear relationship 810 shown in FIG. 8A, it can be detected that when the value of the voltage output by the second end 432 is 10 V, that is, the value V2 of the voltage applied to the cathode of the photoelectric sensor is 10 V, the duty ratio of the corresponding pulse width modulation signal that needs to be applied to the second end 432 is 33.3%. In this case, the duty ratio of the pulse width modulation signal output by the controller 450 is applied to the first end 431, as shown in FIG. 6B, and the duty ratio of the pulse width modulation signal output by the controller 450 is applied to the second end 432 as shown in FIG. 8B.

Step 904: Based on the modulation signal with the duty ratio, control the first end and the second end to output the target voltage to the anode and the cathode of the photoelectric sensor.

After the controller 450 separately determines the duty ratios of the pulse width modulation signals applied to the first end 431 and the second end 432, the controller 450 separately outputs, to the first end 431, the pulse width modulation signal with the duty ratio corresponding to the first end 431, and outputs, to the second end 432, the pulse width modulation signal with the duty ratio corresponding to the second end 432, thus separately controlling values of the voltages output by the first end 431 and the second end 432 to be the target voltage, so that the bias voltage between the two ends of the photoelectric sensor is the target bias voltage.

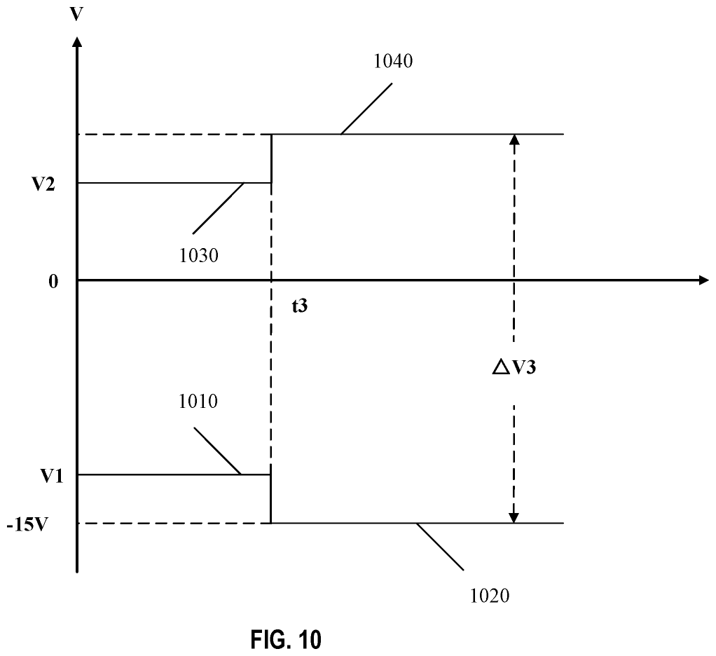

Exemplarily, if an operating temperature of the photoelectric sensor obtained at a moment t3 is greater than an operating temperature of the photoelectric sensor before the moment t3, and the target bias voltage ΔV3 determined based on the operating temperature of the photoelectric sensor at the moment t3 is 25 V, based on the preset ratio, it is determined that a voltage applied to the cathode of the photoelectric sensor is 10 V and a voltage applied to the anode of the photoelectric sensor is −15 V, the duty ratio, determined based on the first preset linear relationship 610 shown in FIG. 6A, of the pulse width modulation signal applied to the first end 431 is 50%, and therefore, the controller 450 can output the pulse width modulation signal 620 with the duty ratio of 50% shown in FIG. 6B to the first end 431 at the moment t3, thus controlling the voltage output by the first end 431 shown in FIG. 10 to jump from a voltage 1010 with a value of V1 shown in FIG. 10 to a target voltage 1020 with the value of −15 V; and the duty ratio, determined based on the second preset linear relationship 810 shown in FIG. 8A, of the pulse width modulation signal applied to the second end 432 is 33.3%, and therefore, the controller 450 can output the pulse width modulation signal 820 with the duty ratio of 33.3% shown in FIG. 8B to the second end 432 at the moment t3, thus controlling the voltage output by the second end 432 shown in FIG. 10 to jump from a voltage 1030 with a value of V2 shown in FIG. 10 to a target voltage 1040 with the value of 10 V, so that the bias voltage between the two ends of the photoelectric sensor reaches the target bias voltage ΔV3.

In this embodiment of this application, when the impact of temperature on the receiving capability of the photoelectric sensor can be eliminated, the target bias voltage between the two ends of the photoelectric sensor is determined based on the operating temperature of the photoelectric sensor, and then, duty ratios of high and low levels of the pulse width modulation signals applied to the first end 431 and the second end 432 are adjusted separately based on the target bias voltage between the two ends of the photoelectric sensor, thus separately controlling the first end 431 and the second end 432 to output different voltages, that is, controlling the voltages applied to the anode and the cathode of the photoelectric sensor, thereby compensating for the receiving capability of the photoelectric sensor affected by the temperature, ensuring the ranging performance of the LiDAR, and improving user experience.

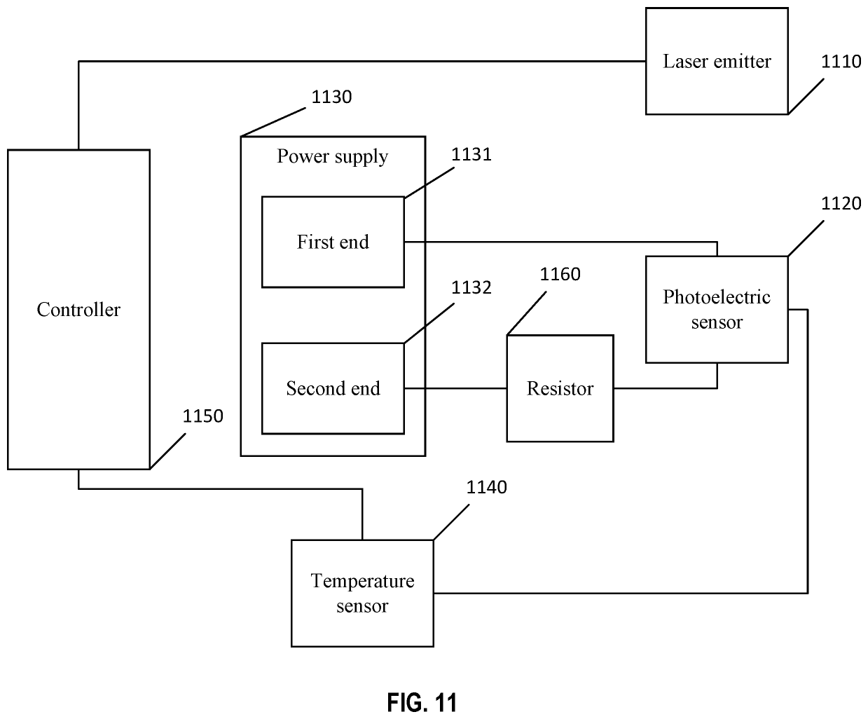

Due to highly reflective targets or strong sunlight causing an instantaneous increase of the operating current of the photoelectric sensor, the operating temperature of the photoelectric sensor will increase instantaneously, and echo signals will become saturated or excessively strong, which affects the actual ranging of the LiDAR. To solve the foregoing problem, based on the circuit shown in FIG. 4, an active voltage regulation circuit may be added. For example, a resistor with a value of 1 kΩ, 2 kΩ, or the like is connected in series between the first end 440 and the cathode of the photoelectric sensor 420, to obtain another LiDAR. FIG. 11 is a schematic structural diagram of another LiDAR according to an exemplary embodiment of this application. As shown in FIG. 11, the LiDAR may include: a laser emitter 1110, a photoelectric sensor 1120, a power supply 1130, a temperature sensor 1140, a controller 1150, and a resistor 1160.

The laser emitter 1110 is configured to emit a laser beam.

The photoelectric sensor 1120 is configured to receive an echo signal generated by the foregoing laser beam.

The power supply 1130 includes a first end 1131 and a second end 1132; the first end 1131 is configured to provide a voltage for the anode of the photoelectric sensor; and the second end 1132 is configured to provide a voltage for the cathode of the photoelectric sensor.

The temperature sensor 1140 is connected to the photoelectric sensor 1120 and is configured to detect the operating temperature of the photoelectric sensor 1120.

An end of the resistor 1160 is connected to the second end 1132, and the other end of the resistor 1160 is connected to the photoelectric sensor 1120, and is configured to reduce the voltage of the cathode of the photoelectric sensor 1120.

The controller 1150 is connected to the laser emitter 1110 and the temperature sensor 1140, and is configured to control the laser emitter 1110 to emit a laser beam and receive the operating temperature output by the temperature sensor 1140.

In this embodiment of this application, when highly reflective targets, strong sunlight, or the like cause the instantaneous increase in the current of the photoelectric sensor 1120, based on Kirchhoffs voltage law, a relatively large voltage drop is generated on the resistor 1160 connected in series, and the voltage of the cathode of the photoelectric sensor 1120 is decreased. That is, when the strong echo signals are received, by using a feature that the current of the photoelectric sensor 1120 is increased instantaneously, the voltage of the cathode of the photoelectric sensor 1120 is reduced through the resistor 1160, and therefore, the bias voltage between the two ends of the photoelectric sensor 1120 is decreased instantaneously, a receiving capability of the photoelectric sensor 1120 becomes weaker, saturation of the echo signals does not occur, and the echo signals can be detected normally. In addition, when the operating temperature of the photoelectric sensor 1120 rises sharply, reducing the voltage of the cathode of the photoelectric sensor 1120 can effectively prolong the service life of the photoelectric sensor 1120.

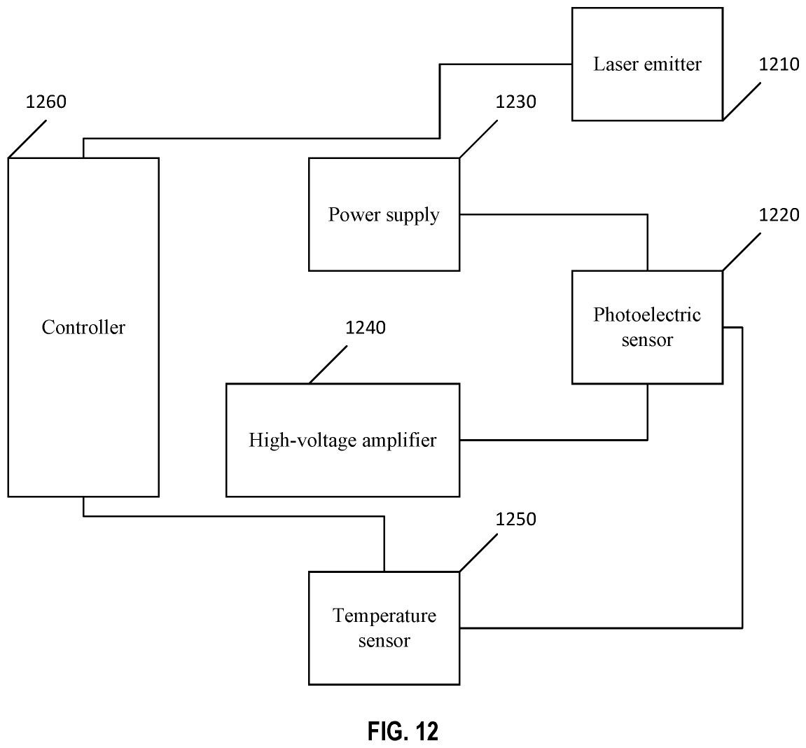

Due to highly reflective targets or strong sunlight cause the instantaneous increase of the operating current of the photoelectric sensor, the operating temperature of the photoelectric sensor will increase instantaneously, and echo signals will become saturated or excessively strong, which affects the actual ranging of the LiDAR. To solve the foregoing problem, an active voltage regulation circuit may be added. In addition to connecting a resistor in series between the first end and the cathode of the photoelectric sensor as shown in FIG. 11, the first end may be further replaced with a high-voltage operational amplifier, to obtain another LiDAR. FIG. 12 is a schematic structural diagram of another LiDAR according to an exemplary embodiment of this application. As shown in FIG. 12, the LiDAR may include: a laser emitter 1210, a photoelectric sensor 1220, a power supply 1230, a high-voltage operational amplifier 1240, a temperature sensor 1250, and a controller 1260.

The laser emitter 1210 is configured to emit a laser beam.

The photoelectric sensor 1220 is configured to receive an echo signal generated by the foregoing laser beam.

The power supply 1230 is connected to the photoelectric sensor 1220, and may include a first end and a second end; the first end is configured to provide a voltage for the anode of the photoelectric sensor; and the second end is configured to provide a voltage for the cathode of the photoelectric sensor.

The temperature sensor 1250 is connected to the photoelectric sensor 1220 and is configured to detect the operating temperature of the photoelectric sensor 1220.

The controller 1260 is connected to the laser emitter 1210 and the temperature sensor 1250, and is configured to control the laser emitter 1210 to emit a laser beam and receive the operating temperature output by the temperature sensor 1250.

The controller 1260 is configured to: if the operating temperature of the photoelectric sensor 1220 satisfies a preset condition, determine that the target bias voltage is a preset bias voltage.

The controller 1260 is also configured to: based on the preset bias voltage, by using the high-voltage operational amplifier 1240, switch the first voltage applied to the cathode of the photoelectric sensor 1220 to a second voltage, where the second voltage is less than the first voltage. The high-voltage operational amplifier 1240 may be a high-speed high-voltage operation amplifier, and all the following embodiments are described by using the high-speed high-voltage operation amplifier as the high-voltage operational amplifier 1240.

In some embodiments, the second end can also be replaced with the high-voltage operational amplifier. Then, by using the high-voltage operational amplifier, based on the preset bias voltage, the controller 1260 is used to switch the first voltage applied to the anode of the photoelectric sensor to the second voltage; and the second voltage is greater than the first voltage, to eliminate the impact of the instantaneous rise of the operating temperature of the photoelectric sensor or the saturation of the echo signals, that is, excessively strong echo signals, on the ranging of the LiDAR.

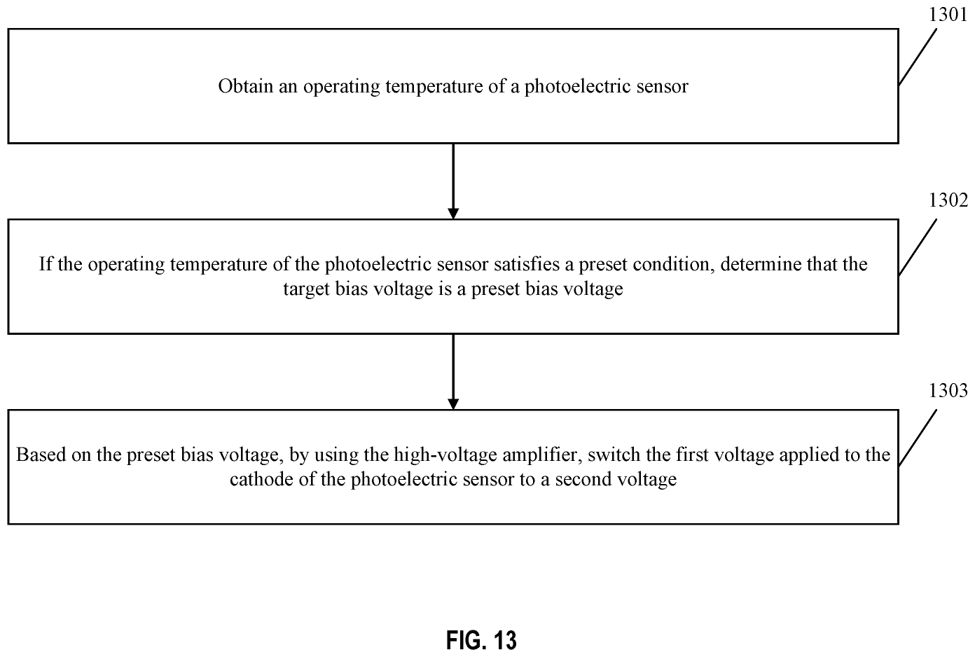

Then, with reference to FIG. 12 and FIG. 13, another LiDAR adjustment method provided in an exemplary embodiment of this application is introduced. FIG. 13 is a schematic flowchart of a LiDAR adjustment method according to an exemplary embodiment of this application. As shown in FIG. 13, the LiDAR adjustment method includes the following steps:

Step 1301: Obtain an operating temperature of a photoelectric sensor.

Step 1301 is consistent with step 201. Details are not described herein again.

Step 1302: If the operating temperature of the photoelectric sensor satisfies a preset condition, determine that the target bias voltage is a preset bias voltage.

If the obtained increase in the operating temperature of the photoelectric sensor 1220 within a preset time period is greater than a preset threshold, that is, the preset condition is satisfied, the target bias voltage can be determined as the preset bias voltage. The foregoing preset bias voltage is a bias voltage between the second voltage corresponding to the second signal that is output by the controller 1260 and that is applied to the cathode of the photoelectric sensor 1220 and the voltage provided by the power supply 1230 for the anode of the photoelectric sensor 1220. The foregoing preset time period may be 1 ms, 1 ns, or the like, which is not limited in this application. The foregoing preset threshold may be 2° C., 6° C., or the like, which is not limited in this application.

Exemplarily, assuming that the preset time period is 2 ms and the preset threshold is 7° C., when the operating temperature of the photoelectric sensor 1220 increases by 8° C. within 2 ms, that is, the increase is greater than 7° C. and satisfies the preset condition. If the voltage provided by the power supply 1230 for the anode of the photoelectric sensor 1220 is −15 V, the second voltage corresponding to the second signal applied to the cathode of the photoelectric sensor 1220 is 5 V, that is, the preset bias voltage is 20 V, and the target bias voltage can be determined to be 20 V.

Step 1303: Based on the preset bias voltage, by using the high-voltage operational amplifier, switch the first voltage applied to the cathode of the photoelectric sensor to a second voltage.

When the obtained increase in the operating temperature of the photoelectric sensor 1220 within a preset time period is less than or equal to a preset threshold, that is, the preset condition is not satisfied, a first signal output by the controller 1260 is jointly used with a basal signal applied to the cathode of the photoelectric sensor 1220, and the high-voltage operational amplifier 1240 converts the first signal and the foregoing basal signal into the first voltage. When the obtained increase in the operating temperature of the photoelectric sensor 1220 within a preset time period is greater than the preset threshold and satisfies the preset condition, based on the preset bias voltage, the controller 1260 may switch a high-level signal, namely the first signal, originally applied to the cathode of the photoelectric sensor to a low-level signal, namely a second signal, that is, the controller 1260 switches the voltage applied to the cathode of the photoelectric sensor from a high level to a low level, the basal signal applied to the cathode of the photoelectric sensor 1220 is jointly used, and therefore, the high-voltage operational amplifier 1240 converts the second signal and the basal signal into the second voltage. In other words, when the operating temperature of the photoelectric sensor 1220 changes abruptly, the controller 1260 can directly output the low-level signal, that is, the second signal, based on the preset bias voltage, and use the high-voltage operational amplifier 1240 to jointly convert the second signal applied to the cathode of the photoelectric sensor 1220 and the basal signal into the second voltage, thereby reducing the bias voltage between the two ends of the photoelectric sensor. The foregoing basal signal is a signal corresponding to a basal voltage applied to the cathode of the photoelectric sensor 1220.

Exemplarily, the foregoing basal signal may be a level signal with a value of 2 V, 3 V, or the like, which is not limited in this application. The foregoing basal signal can be converted by the foregoing high-voltage operational amplifier 1240 into the basal voltage applied to the cathode of the photoelectric sensor 1220. The foregoing first signal is a signal corresponding to the first voltage applied to the cathode of the photoelectric sensor 1220; the foregoing second signal is a signal corresponding to the second voltage applied to the cathode of the photoelectric sensor 1220; and the foregoing second voltage is less than the foregoing first voltage.

In this embodiment of this application, when the photoelectric sensor receives the strong echo signal, the operating temperature of the photoelectric sensor rises sharply. When the controller detects that the temperature satisfies the preset condition, the high-voltage operational amplifier is used to switch the first signal applied to the cathode of the photoelectric sensor to the second signal, that is, the voltage applied to the cathode of the photoelectric sensor is instantly decreased to a low level, so that the bias voltage between the two ends of the photoelectric sensor becomes smaller, thereby effectively detecting the strong echo signal. With the recovery of the operating temperature of the photoelectric sensor, when the strong echo signal disappears, the controller can restore to the high level by outputting a level switching signal again, thereby further ensuring ranging under a normal condition. In this embodiment of this application, when ranging is not performed, the voltage applied to the cathode of the photoelectric sensor can be switched to the low level, thereby reducing the power consumption of the entire apparatus during operation.

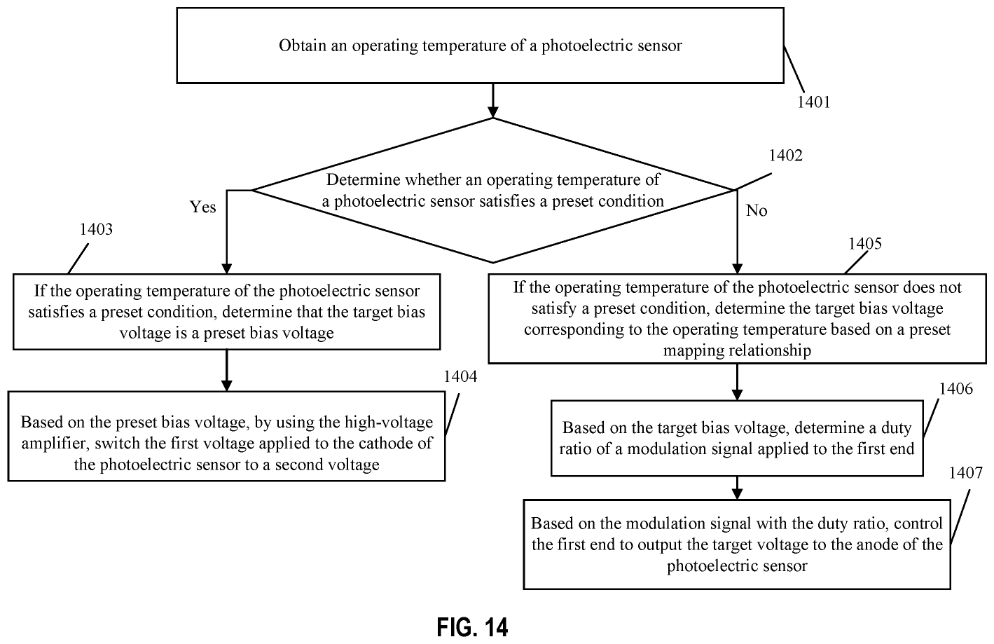

To eliminate the impact of the instantaneous rise of the operating temperature, caused by highly reflective targets, strong sunlight, or the like, of the photoelectric sensor and the excessively strong echo signals on actual ranging of the LiDAR, and compensate for the receiving capability of the photoelectric sensor that is affected when the operating temperature of the photoelectric sensor slowly changes due to factors such as an environmental change or device aging, the voltage applied to the anode of the photoelectric sensor may be adjusted based on the operating temperature of the photoelectric sensor and the preset mapping relationship between the bias voltage between the two ends of the photoelectric sensor and the operating temperature while adding the active voltage regulation circuit to the cathode of the photoelectric sensor. FIG. 14 is a schematic flowchart of a LiDAR adjustment method according to an exemplary embodiment of this application.

As shown in FIG. 14, the LiDAR adjustment method includes the following steps:

Step 1401: Obtain an operating temperature of a photoelectric sensor.

Step 1401 is consistent with step 201. Details are not described herein again.

Step 1402: Determine whether an operating temperature of a photoelectric sensor satisfies a preset condition.

If the obtained increase in the operating temperature of the photoelectric sensor 1220 within a preset time period is greater than a preset threshold, that is, the preset condition is satisfied, it can be determined whether the operating temperature of the photoelectric sensor 1220 satisfies the preset condition. The foregoing preset time period may be 1 ms, 1 ns, or the like, which is not limited in this application. The foregoing preset threshold may be 2° C., 6° C., or the like, which is not limited in this application.

Exemplarily, if the preset time period is 2 ms, the preset threshold is 7° C., and the operating temperature of the photoelectric sensor 1220 increases by 8° C. within 2 ms, it can be determined that the operating temperature of the photoelectric sensor 1220 satisfies the preset condition.

Step 1403: If the operating temperature of the photoelectric sensor satisfies a preset condition, determine that the target bias voltage is a preset bias voltage.

Step 1403 is consistent with step 1302. Details are not described herein again.

Step 1404: Based on the preset bias voltage, by using the high-voltage operational amplifier, switch the first voltage applied to the cathode of the photoelectric sensor to a second voltage.

If the obtained increase in the operating temperature of the photoelectric sensor 1220 within a preset time period is greater than a preset threshold, that is, the preset condition is satisfied, a first signal output by the controller 1260 may be switched to a second signal, to be jointly used with a basal signal applied to the cathode of the photoelectric sensor 1220, and the high-voltage operational amplifier 1240 converts the foregoing second signal and the foregoing basal signal into the second voltage. In other words, when the operating temperature of the photoelectric sensor 1220 changes abruptly, the controller 1260 may output a level switching signal to switch a high-level signal, namely the first signal, originally applied to the cathode of the photoelectric sensor to a low-level signal, namely a second signal, that is, the controller 1260 switches the voltage applied to the cathode of the photoelectric sensor from a high level to a low level, and the high-voltage operational amplifier 1240 jointly converts the second signal and the basal signal applied to the cathode of the photoelectric sensor 1220 into the second voltage, thereby reducing the bias voltage between the two ends of the photoelectric sensor. The foregoing basal signal is a signal corresponding to a basal voltage applied to the cathode of the photoelectric sensor 1220. Exemplarily, the foregoing basal signal may be a level signal with a value of 2 V, 3 V, or the like, which is not limited in this application. The foregoing basal signal can be converted by the foregoing high-voltage operational amplifier 1240 such as the high-speed high-voltage operation amplifier into the basal voltage applied to the cathode of the photoelectric sensor 1220. The foregoing first signal is a signal corresponding to the first voltage applied to the cathode of the photoelectric sensor 1220; the foregoing second signal is a signal corresponding to the second voltage applied to the cathode of the photoelectric sensor 1220; and the foregoing second voltage is less than the foregoing first voltage. The foregoing preset time period may be 1 ms, 1 ns, or the like, which is not limited in this application. The foregoing preset threshold may be 2° C., 6° C., or the like, which is not limited in this application.

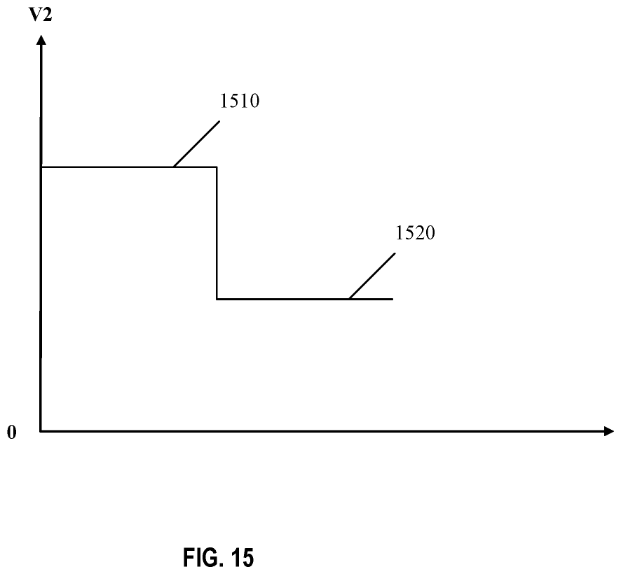

Exemplarily, if the preset time period is 1 ms and the preset threshold is 6° C., when the operating temperature of the photoelectric sensor 1220 increases by 8° C. within 1 ms, that is, the increase is greater than 6° C. and satisfies the preset condition, the controller 1260 can switch the original output first signal to the second signal by outputting the level switching signal, to control switching of the voltage applied to the cathode of the photoelectric sensor 1220 from the first voltage 1510 to the second voltage 1520, as shown in FIG. 15.

Step 1405: If the operating temperature of the photoelectric sensor does not satisfy a preset condition, determine the target bias voltage corresponding to the operating temperature based on a preset mapping relationship.

If the obtained increase in the operating temperature of the photoelectric sensor 1220 within a preset time period is less than or equal to a preset threshold, that is, the preset condition is not satisfied, a process of determining the target bias voltage corresponding to the operating temperature is consistent with step 202. Details are not described herein again.

Step 1406: Based on the target bias voltage, determine a duty ratio of a modulation signal applied to the first end.

The value of the voltage applied to the cathode of the photoelectric sensor 1420 is first determined based on the target bias voltage, and then the duty ratio of the modulation signal applied to the first end is determined based on the value of the voltage applied to the cathode of the photoelectric sensor 1420 and the target bias voltage. Exemplary implementation processes are the same as step 503 and step 504. Details are not described herein again.

In some embodiments, the duty ratio of the modulation signal applied to the second end or the duty ratios of the modulation signals applied to both the first end and the second end can also be determined based on the target bias voltage, that is, the second end is controlled to output the target voltage to the anode of the photoelectric sensor, or not only the first end is controlled to output the target voltage to the cathode of the photoelectric sensor, but also the second end is controlled to output the target voltage to the anode of the photoelectric sensor. This is not limited in this application.

Step 1407: Based on the modulation signal with the duty ratio, control the first end to output the target voltage to the anode of the photoelectric sensor.

Step 1407 is consistent with step 505. Details are not described herein again.

In this embodiment of this application, when the photoelectric sensor receives the strong echo signal, the operating temperature of the photoelectric sensor rises sharply. When the controller detects that the operating temperature of the photoelectric sensor satisfies the preset condition, by using the level switching signal, the high-voltage operational amplifier instantly decreases the voltage applied to the cathode of the photoelectric sensor to a low level, so that the bias voltage between the two ends of the photoelectric sensor becomes smaller, thereby effectively detecting the strong echo signal. When the operating temperature of the photoelectric sensor slowly changes due to factors such as an environmental change or device aging, that is, the controller detects that the operating temperature of the photoelectric sensor does not satisfy the preset condition, the voltage applied to the anode of the photoelectric sensor may be adjusted based on the operating temperature of the photoelectric sensor and the preset mapping relationship between the bias voltage between the two ends of the photoelectric sensor and the operating temperature, to compensate for the receiving capability of the photoelectric sensor that is affected by the operating temperature.

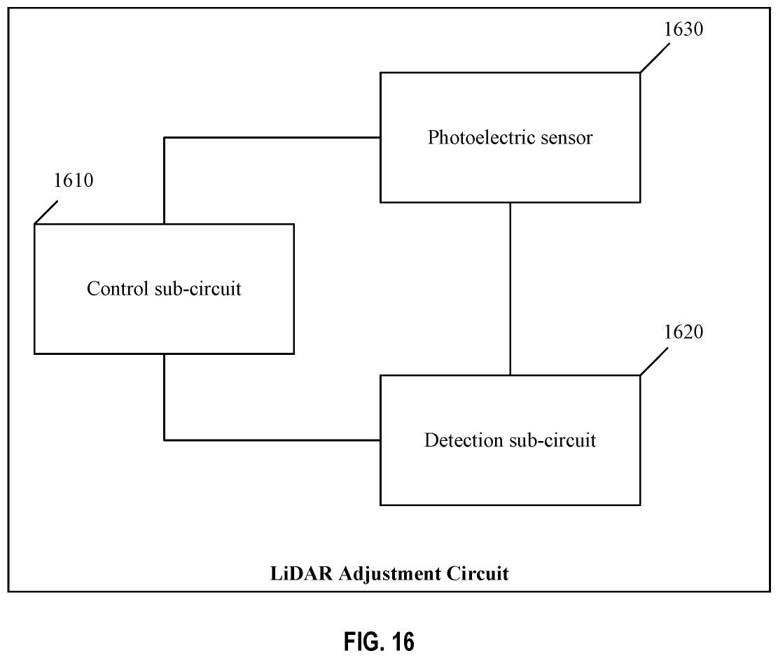

FIG. 16 shows a LiDAR adjustment circuit provided in an embodiment of this application. The LiDAR adjustment circuit includes: a control sub-circuit 1610, a detection sub-circuit 1620, and a photoelectric sensor 1630;

the detection sub-circuit 1620 is connected to the photoelectric sensor 1630 and configured to detect an operating temperature of the photoelectric sensor 1630;

the control sub-circuit 1610 is connected to the detection sub-circuit 1620 and the photoelectric sensor 1630;

the photoelectric sensor 1630 is configured to receive an echo signal; and

the control sub-circuit 1610 is configured to control the detection sub-circuit 1620 to detect the operating temperature of the photoelectric sensor 1630, and is further configured to: determine a target bias voltage based on the operating temperature, and adjust a value of a voltage applied to at least one of an anode and a cathode of the photoelectric sensor 1630 based on the target bias voltage. The target bias voltage is a difference between the voltages applied to the anode and the cathode of the photoelectric sensor 1630.

In an exemplary implementation, the control sub-circuit 1610 is configured to: determine the target bias voltage corresponding to the operating temperature based on a preset mapping relationship, and based on the target bias voltage, adjust the voltage applied to at least one of the anode and the cathode of the photoelectric sensor 1630. The preset mapping relationship includes a plurality of temperatures and bias voltages corresponding to different temperatures respectively.

In an exemplary implementation, the control sub-circuit 1610 includes a power supply and a controller, and the power supply includes a first end and a second end;

the first end is connected to the cathode of the photoelectric sensor 1630, and is configured to provide a voltage for the cathode of the photoelectric sensor 1630;

the second end is connected to the anode of the photoelectric sensor 1630, and is configured to provide a voltage for the anode of the photoelectric sensor 1630; and

the controller is configured to: based on the target bias voltage, determine a duty ratio of a modulation signal applied to at least one of the anode and the cathode of the photoelectric sensor 1630, and output the modulation signal to at least one of the first end and the second end based on the duty ratio, to provide the voltage for at least one of the cathode and the anode of the photoelectric sensor 1630.

In an exemplary implementation, the controller is configured to: determine a value of the voltage applied to the cathode of the photoelectric sensor 1630;

the controller is also configured to: based on the target bias voltage and the value of the voltage applied to the cathode of the photoelectric sensor 1630, determine a duty ratio of a modulation signal applied to the anode of the photoelectric sensor 1630, and output the modulation signal to the second end based on the duty ratio, to provide a voltage for the anode of the photoelectric sensor 1630;

or

the controller is configured to determine a value of the voltage applied to the anode of the photoelectric sensor 1630; and

the controller is also configured to: based on the target bias voltage and the value of the voltage applied to the anode of the photoelectric sensor 1630, determine a duty ratio of a modulation signal applied to the cathode of the photoelectric sensor 1630, and output the modulation signal to the first end based on the duty ratio, to provide a voltage for the cathode of the photoelectric sensor 1630.

In an exemplary implementation, the LiDAR adjustment circuit further includes a voltage step-down sub-circuit;

an end of the voltage step-down sub-circuit is connected to the first end;

another end of the voltage step-down sub-circuit is connected to the photoelectric sensor 1630; and

the voltage step-down sub-circuit is configured to lower the voltage of the cathode of the photoelectric sensor 1630.

In an exemplary implementation, the control sub-circuit 1610 includes a power supply, a controller, and a high-voltage operational amplifier;

the power supply is configured to supply energy to the photoelectric sensor and apply a bias voltage to both ends of the photoelectric sensor;

the controller is configured to: if the operating temperature of the photoelectric sensor 1630 satisfies a preset condition, determine that the target bias voltage is a preset bias voltage; and

the controller is also configured to: based on the preset bias voltage, by using the high-voltage operational amplifier, switch the first voltage applied to the cathode of the photoelectric sensor 1630 to a second voltage, where the second voltage is less than the first voltage.

In an exemplary implementation, the power supply includes a first end and a second end;

the controller is also configured to: if the operating temperature of the photoelectric sensor does not satisfy a preset condition, determine the target bias voltage corresponding to the operating temperature based on a preset mapping relationship, where the preset mapping relationship includes a plurality of temperatures and bias voltages corresponding to different temperatures respectively; and

the controller is also configured to: determine a value of the voltage applied to the cathode of the photoelectric sensor;

based on the target bias voltage and the value of the voltage applied to the cathode of the photoelectric sensor, determine a value of the voltage applied to the anode of the photoelectric sensor;

determine the duty ratio of the modulation signal based on the value of the voltage of the anode of the photoelectric sensor; and

based on the modulation signal with the duty ratio, control the first end to output the target voltage to the anode of the photoelectric sensor; or

determine a value of the voltage applied to the anode of the photoelectric sensor;

based on the target bias voltage and the value of the voltage applied to the anode of the photoelectric sensor, determine a value of the voltage applied to the cathode of the photoelectric sensor;

determine the duty ratio of the modulation signal based on the value of the voltage of the cathode of the photoelectric sensor; and

based on the modulation signal with the duty ratio, control the second end to output the target voltage to the cathode of the photoelectric sensor.

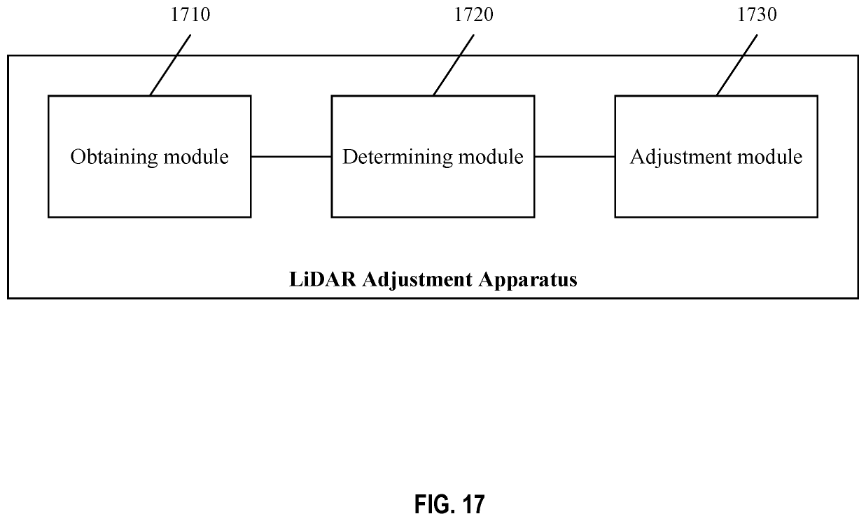

FIG. 17 shows an automatic LiDAR adjustment apparatus according to an embodiment of this application. The automatic LiDAR adjustment apparatus is applied to the LiDAR. The LiDAR includes a photoelectric sensor, and the automatic LiDAR adjustment apparatus includes:

an obtaining module 1710, configured to obtain an operating temperature of a photoelectric sensor;

a determining module 1720, configured to determine a target bias voltage based on the operating temperature, where the target bias voltage is a difference between voltages applied to a cathode and an anode of the photoelectric sensor; and

an adjustment module 1730, configured to: based on the target bias voltage, adjust the voltages applied to at least one of the anode and the cathode of the photoelectric sensor.

In an exemplary implementation, the determining module 1720 is configured to: determine the target bias voltage corresponding to the operating temperature based on a preset mapping relationship, where the preset mapping relationship includes a plurality of temperatures and bias voltages corresponding to different temperatures respectively.

In an exemplary implementation, the LiDAR further includes a power supply, and the adjustment module 1730 includes:

a determining unit, configured to: based on the target bias voltage, determine a duty ratio of a modulation signal applied to the power supply; and

an outputting unit, configured to: based on the modulation signal with the duty ratio, control the power supply to output a target voltage to at least one of the anode and the cathode of the photoelectric sensor.

In an exemplary implementation, the power supply includes a first end and a second end, and the determining module 1720 is further configured to determine the value of the voltage applied to the cathode of the photoelectric sensor; and

the determining unit is configured to: based on the target bias voltage and the value of the voltage applied to the cathode of the photoelectric sensor, determine a value of the voltage applied to the anode of the photoelectric sensor; and

determine the duty ratio of the modulation signal based on the value of the voltage of the anode of the photoelectric sensor, where

the outputting unit is configured to: based on the modulation signal with the duty ratio, control the first end to output the target voltage to the anode of the photoelectric sensor; or

the determining module 1720 is further configured to determine a value of the voltage applied to the anode of the photoelectric sensor; and

the determining unit is configured to: based on the target bias voltage and the value of the voltage applied to the anode of the photoelectric sensor, determine the value of the voltage applied to the cathode of the photoelectric sensor; and

determine the duty ratio of the modulation signal based on the value of the voltage of the cathode of the photoelectric sensor, where

the outputting unit is configured to: based on the modulation signal with the duty ratio, control the second end to output the target voltage to the cathode of the photoelectric sensor.

In an exemplary implementation, the LiDAR further includes a high-voltage operational amplifier;

the determining module 1720 is configured to: if the operating temperature of the photoelectric sensor satisfies a preset condition, determine that the target bias voltage is a preset bias voltage; and

the adjustment module 1730 includes:

a switching unit, configured to: based on the preset bias voltage, by using the high-voltage operational amplifier, switch the first voltage applied to the cathode of the photoelectric sensor to a second voltage, where the second voltage is less than the first voltage.

In an exemplary implementation, the LiDAR further includes a power supply, the power supply includes a first end and a second end, and the determining module 1720 is also configured to: if the operating temperature of the photoelectric sensor does not satisfy a preset condition, determine the target bias voltage corresponding to the operating temperature based on a preset mapping relationship, where the preset mapping relationship includes a plurality of temperatures and bias voltages corresponding to different temperatures respectively; and

the determining unit is configured to: determine a value of the voltage applied to the cathode of the photoelectric sensor;

based on the target bias voltage and the value of the voltage applied to the cathode of the photoelectric sensor, determine a value of the voltage applied to the anode of the photoelectric sensor; and

determine the duty ratio of the modulation signal based on the value of the voltage of the anode of the photoelectric sensor, where

the outputting unit is configured to: based on the modulation signal with the duty ratio, control the first end to output the target voltage to the anode of the photoelectric sensor; or

the determining unit is configured to: determine a value of the voltage applied to the anode of the photoelectric sensor;

based on the target bias voltage and the value of the voltage applied to the anode of the photoelectric sensor, determine the value of the voltage applied to the cathode of the photoelectric sensor; and

determine the duty ratio of the modulation signal based on the value of the voltage of the cathode of the photoelectric sensor, where

the outputting unit is configured to: based on the modulation signal with the duty ratio, control the second end to output the target voltage to the cathode of the photoelectric sensor.

Division of the modules in the foregoing LiDAR adjustment apparatus is only used as an example for description. In another embodiment, the LiDAR adjustment apparatus can be divided into different modules as required to perform all or some of the functions of the foregoing LiDAR adjustment apparatus. Each module in the LiDAR adjustment apparatus provided in this embodiment of this specification may be implemented in a form of a computer program. The computer program can run on a terminal or a server. A program module formed by the computer program can be stored in a memory of the terminal or the server. When the computer program is executed by the processor, all or some of the steps of the LiDAR adjustment method described in the embodiments of this specification are implemented.

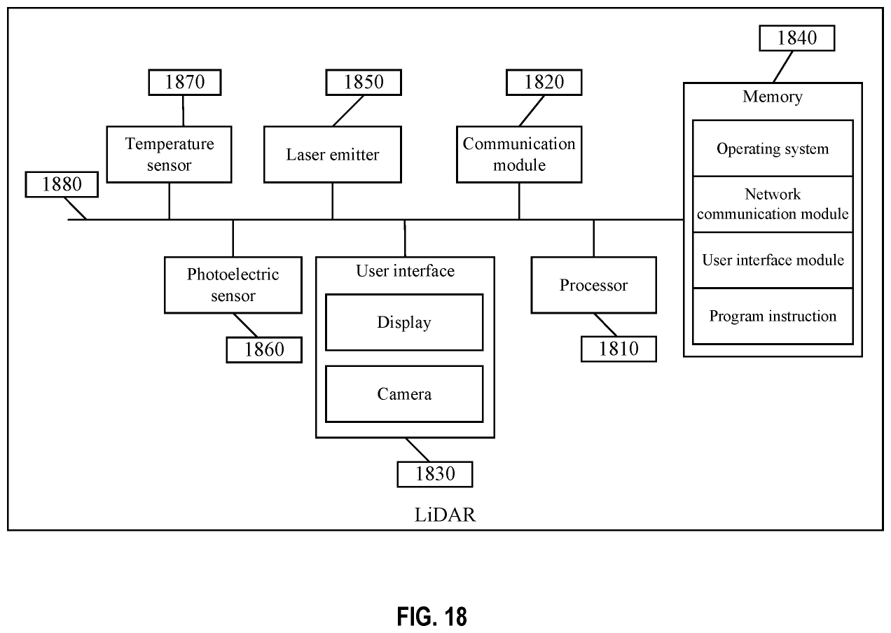

FIG. 18 is a schematic structural diagram of another LiDAR according to an embodiment of this application. As shown in FIG. 18, the LiDAR may include: at least one processor 1810, at least one communication module 1820, a user interface 1830, a memory 1840, a laser emitter 1850, a photoelectric sensor 1860, a temperature sensor 1870, and at least one communication bus 1880.

Herein, the communication bus 1880 is configured to implement a connection and communication between these components.

In some embodiments, the communication module 1820 may include a low-power Bluetooth module, a near field communication (NFC) module, a wireless fidelity (Wi-Fi) module, and the like.

Herein, the user interface 1830 may include a display and a camera, or the user interface 1830 may further include a standard wired interface and a wireless interface.

Herein, the memory 1840 is configured to store information such as information input by the user interface 1830, a second pitching drive voltage obtained by the processor 1810, and executable program code.

Herein, the laser emitter 1850 is configured to emit a laser beam.

Herein, the photoelectric sensor 1860 receives an echo signal generated by the laser beam.

Herein, the temperature sensor 1870 is connected to the photoelectric sensor 1860 and is configured to detect the operating temperature of the photoelectric sensor 1860.

Herein, the processor 1810 may include one or more processing cores. The processor 1810 uses various interfaces and lines to connect various parts of the entire electronic device 1800, and executes various functions and processes data of the LiDAR by running or executing instructions, programs, code sets, or instruction sets stored in the memory 1840, and invoking data stored in the memory 1840. In some embodiments, the processor 1810 may be realized in at least one hardware form of digital signal processing (DSP), a field-programmable gate array (FPGA), and a programmable logic array (PLA). The processor 1810 may integrate a combination of one or more of a central processing unit (CPU), a graphics processing unit (GPU), a modem, and the like. The GPU is configured to render and draw content that needs to be displayed on a display. The modem is configured to process wireless communication. It may be understood that the forgoing modem may not be integrated into the processor 1810, and may be implemented by one chip independently.

The memory 1840 may include a random access memory (RAM), or a read-only memory (ROM). In some embodiments, the memory 1840 includes a non-transitory computer-readable medium. The memory 1840 may be configured to store instructions, programs, codes, code sets, or instruction sets. The memory 1840 may include a program storage region and a data storage region. The program storage region may store instructions for implementing the operating system, instructions for at least one function (for example, an adjustment function, a determining function, and an obtaining function), and instructions for implementing each of the foregoing method embodiments. In some embodiments, the memory 1840 may also be at least one storage device distant from the forgoing processor 1810. As shown in FIG. 18, as a computer storage medium, the memory 1840 may include an operating system, a network communications module, a user interface module, and a program instruction.

In the LiDAR shown in FIG. 18, the user interface 1830 is mainly configured to provide an input interface for a user to obtain data input by the user; and the processor 1810 can be used to invoke an application program stored in the memory 1840, and perform the following operations:

obtaining an operating temperature of the photoelectric sensor;

determining a target bias voltage based on the operating temperature, where the target bias voltage is a difference between voltages applied to a cathode and an anode of the photoelectric sensor; and

based on the target bias voltage, adjusting the voltages applied to at least one of the anode and the cathode of the photoelectric sensor.

In some exemplary embodiments, when determining a target bias voltage based on the operating temperature, the processor 1810 is configured to:

determine the target bias voltage corresponding to the operating temperature based on a preset mapping relationship, where the preset mapping relationship includes a plurality of temperatures and bias voltages corresponding to different temperatures respectively.

In some exemplary embodiments, the LiDAR further includes a power supply, and based on the target bias voltage, when adjusting the voltages applied to t at least one of the anode and the cathode of the photoelectric sensor, the processor 1810 is configured to: based on the target bias voltage, determine a duty ratio of a modulation signal applied to the power supply; and

based on the modulation signal with the duty ratio, control the power supply to output a target voltage to at least one of the anode and the cathode of the photoelectric sensor.

In some exemplary embodiments, the power supply includes a first end and a second end, and based on the target bias voltage, when determining a duty ratio of a modulation signal applied to the power supply and based on the modulation signal with the duty ratio, when controlling the power supply to output a target voltage to at least one of the anode and the cathode of the photoelectric sensor, the processor 1810 is configured to:

determine a value of the voltage applied to the cathode of the photoelectric sensor;

based on the target bias voltage and the value of the voltage applied to the cathode of the photoelectric sensor, determine a value of the voltage applied to the anode of the photoelectric sensor;

based on the target bias voltage and the value of the voltage applied to the cathode of the photoelectric sensor, determine a value of the voltage applied to the anode of the photoelectric sensor;

determine the duty ratio of the modulation signal based on the value of the voltage of the anode of the photoelectric sensor; and

based on the modulation signal with the duty ratio, control the first end to output the target voltage to the anode of the photoelectric sensor; or

determine a value of the voltage applied to the anode of the photoelectric sensor;

based on the target bias voltage and the value of the voltage applied to the anode of the photoelectric sensor, determine a value of the voltage of a modulation signal applied to the cathode of the photoelectric sensor;

determine the duty ratio of the modulation signal based on the value of the voltage of the cathode of the photoelectric sensor; and

based on the modulation signal with the duty ratio, control the second end to output the target voltage to the cathode of the photoelectric sensor.

In some exemplary embodiments, the LiDAR further includes a high-voltage operational amplifier; and

when determining a target bias voltage based on the operating temperature, the processor 1810 is configured to:

if the operating temperature of the photoelectric sensor satisfies a preset condition, determine that the target bias voltage is a preset bias voltage.

Based on the target bias voltage, when adjusting the voltages applied to the at least one of anode and the cathode of the photoelectric sensor, the processor 1810 is configured to:

based on the preset bias voltage, by using the high-voltage operational amplifier, switch the first voltage applied to the cathode of the photoelectric sensor to a second voltage, where the second voltage is less than the first voltage.

In some exemplary embodiments, the LiDAR further includes a power supply. The power supply includes a first end and a second end. When determining a target bias voltage based on the operating temperature, the processor 1810 is configured to:

if the operating temperature of the photoelectric sensor does not satisfy a preset condition, determine the target bias voltage corresponding to the operating temperature based on a preset mapping relationship, where the preset mapping relationship includes a plurality of temperatures and bias voltages corresponding to different temperatures respectively.

Based on the target bias voltage, when adjusting the voltages applied to at least one of the anode and the cathode of the photoelectric sensor, the processor 1810 is configured to:

determine a value of the voltage applied to the cathode of the photoelectric sensor;

based on the target bias voltage and the value of the voltage applied to the cathode of the photoelectric sensor, determine a value of the voltage applied to the anode of the photoelectric sensor;

determine the duty ratio of the modulation signal based on the value of the voltage of the anode of the photoelectric sensor; and

based on the modulation signal with the duty ratio, control the first end to output the target voltage to the anode of the photoelectric sensor;

or

determine a value of the voltage applied to the anode of the photoelectric sensor;

based on the target bias voltage and the value of the voltage applied to the anode of the photoelectric sensor, determine a value of the voltage applied to the cathode of the photoelectric sensor;

determine the duty ratio of the modulation signal based on the value of the voltage of the cathode of the photoelectric sensor; and

based on the modulation signal with the duty ratio, control the second end to output the target voltage to the cathode of the photoelectric sensor.

An embodiment of this application further provides a computer storage medium, where the computer storage medium stores an instruction, and when running on a computer or a processor, the instruction enables the computer or the processor to perform one or more steps in any one of the foregoing methods. If each component module in a related apparatus connected to an automatic LiDAR adjustment apparatus is implemented in a form of a software functional unit and sold or used as an independent product, the component module can be stored in the storage medium.

Due to highly reflective targets and strong sunlight causing the instantaneous increase of the operating current of the photoelectric sensor, the operating temperature of the photoelectric sensor will increase instantaneously. The active voltage regulation circuit disclosed in the foregoing embodiments is added to reduce the bias voltage between the two ends of the photoelectric sensor, thus adjusting the operating current of the photoelectric sensor. In addition, the bias voltage between the two ends of the photoelectric sensor can also be adjusted by monitoring the change in the operating current of the photoelectric sensor.

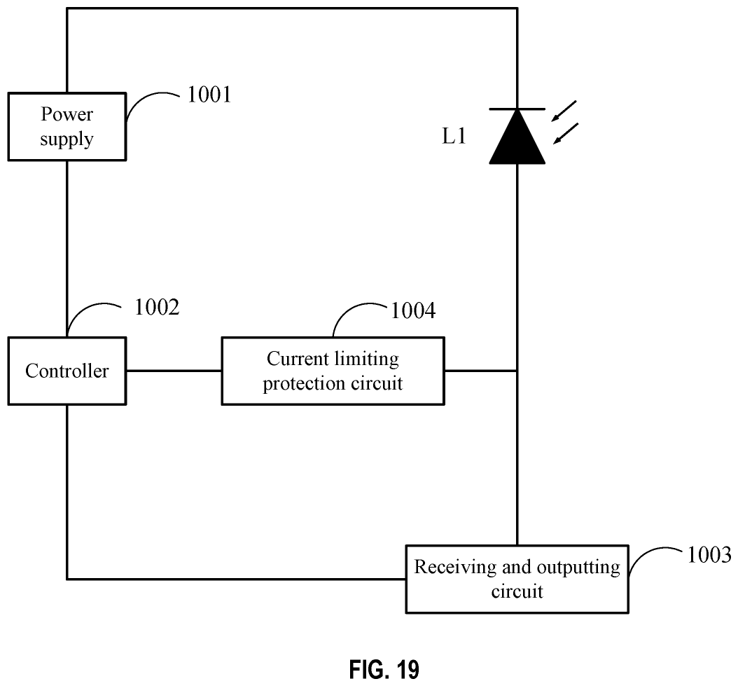

FIG. 19 is a schematic diagram of another sensor protection circuit of a LiDAR according to an exemplary embodiment of this application. As shown in FIG. 19, the LiDAR may include: a power supply 1001, a first photoelectric sensor L1, a receiving and outputting circuit 1003, a current limiting protection circuit 1004, and a controller 1002. A first end of the power supply 1001 is connected to a cathode of the first photoelectric sensor L1, a first end of the controller 1002 is connected to the current limiting protection circuit 1004, a second end of the controller 1002 is connected to the receiving and outputting circuit 1003, a third end of the controller 1002 is connected to a second end of the power supply 1001, an anode of the first photoelectric sensor L1 is connected to the receiving and outputting circuit 1004, and the current limiting protection circuit 1003 is connected to the anode of the first photoelectric sensor L1.

The power supply 1001 in this embodiment and the power supply 130 in the foregoing embodiment have similar functions, the first photoelectric sensor L1 and the photoelectric sensor 120 in the foregoing embodiment have similar functions, the controller 1002 and the controller 150 in the foregoing embodiment have similar functions, and the current limiting protection circuit 1004 and the active voltage regulation circuit in the foregoing embodiment have similar functions.

A laser signal emitted by the LiDAR is reflected by a target object to form a laser echo signal, and the first photoelectric sensor L1 receives the laser echo signal. When a bias voltage formed by the power supply 1001 and the current limiting protection circuit 1004 is greater than a breakdown voltage, the laser echo signal is converted into a first current signal, and the first current signal is sent to the receiving and outputting circuit 1003 for processing to obtain the first echo signal.

The controller 1002 is configured to receive and parse the first echo signal of the receiving and outputting circuit 1003 to obtain a signal feature value, and output an initial voltage signal to the current limiting protection circuit 1004 based on the signal feature value. The signal feature value may be a current value or a voltage value of the first echo signal, for example, a voltage value obtained by parsing the first echo signal. When the voltage value is greater than a voltage threshold, the initial voltage signal is output to the current limiting protection circuit 1004.

It can be understood that the receiving and outputting circuit 1003 receives the first current signal from the first photoelectric sensor L1, performs processing such as noise reduction and amplification on the current signal to obtain the first echo signal, and sends the first echo signal to a circuit of the controller 1002.

In an embodiment, the receiving and outputting circuit 1003 includes: a transimpedance amplification circuit and a processing circuit. The transimpedance amplification circuit is connected to the first photoelectric sensor L1, and is configured to convert the first current signal into a first voltage signal and perform amplification processing to obtain an amplified voltage signal. The processing circuit is connected to the transimpedance amplification circuit, and is configured to receive the amplified voltage signal, and send, to the controller 1002, the first echo signal obtained after the voltage signal is processed by the analog-to-digital converter. It can be understood that the current value of the first current signal generated by the first photoelectric sensor L1 based on the laser echo signal is relatively small, and therefore, the first current signal needs to be converted by the transimpedance amplification circuit into the first voltage signal, and needs to be amplified and shaped, to help the processing circuit process a signal.

It can be understood that the current limiting protection circuit 1004 is configured to perform amplification processing on the initial voltage signal based on a preset operation rule to obtain a negative bias voltage signal, and load the negative bias voltage signal to the anode of the first photoelectric sensor L1, to reduce a current value of the first photoelectric sensor L1.

For example, an operating process of the sensor protection circuit in this application is as follows. The first photoelectric sensor L1 includes a highly sensitive SiPM (silicon photomultiplier). An avalanche effect occurs when photons are received, and current output by each micro-unit in the first photoelectric sensor L1 suddenly increases. The current value and the number of photons are linearly positively correlated, and the photoelectric amplification capability (namely, Gain) is positively correlated to the bias voltage. At a moment T1, the controller 1002 outputs a drive voltage signal V1 to the current limiting protection circuit 1004, and the current limiting protection circuit 1004 receives and then amplifies the drive voltage signal V1 to obtain a negative bias voltage signal Vm, and loads the negative bias voltage signal Vm onto the anode of the first photoelectric sensor L1. The first photoelectric sensor L1 outputs the first current signal with the current value of Ia, the receiving and outputting circuit 1003 receives and then processes the first current signal to obtain a first echo signal with a voltage value of VL, and transmits the first echo signal VL to the controller 1002. The controller 1002 receives the first echo signal VL, parses the voltage value VL as the signal feature value, and compares the voltage value VL with a voltage threshold V0. When the voltage value VL of the first echo signal is greater than the voltage threshold V0, the controller 1002 outputs an initial voltage signal V2 to the current limiting protection circuit 1004, where the voltage value V2 of the initial voltage signal is greater than the voltage value V1 of the drive voltage signal. The current limiting protection circuit 1004 receives and then amplifies the initial voltage signal V2 to obtain a negative bias voltage signal Vn, and loads the negative bias voltage signal Vn onto the anode of the first photoelectric sensor L1. Because a positive bias voltage signal Vd loaded by the power supply 1001 to the first photoelectric sensor L1 is unchanged, the bias voltage of the first photoelectric sensor L1 decreases, a photoelectric amplification capability decreases (that is, the gain decreases), and a current value of the current Ia of the first photoelectric sensor L1 becomes smaller.

The beneficial effects provided by the technical solutions in some embodiments of this application include at least as follows. The current limiting protection circuit can be used to limit the operating current of the photoelectric sensor, to prevent an excessively large operating current from generating heat inside the photoelectric sensor, which otherwise causes abnormal operation and even damage to the photoelectric sensor, thereby significantly improving the operation reliability of the photoelectric sensor when receiving high reflected energy, for example, reliability when the object is highly reflective or the object is at an extremely close distance, and improving the ranging ability of the photoelectric sensor.

Detection of the operating temperature of the photoelectric sensor and adjustment of the bias voltage based on the mapping relationship between the operating temperature and the bias voltage disclosed in the foregoing embodiments, and detection of the operating current of the photoelectric sensor and adjustment of the bias voltage based on the value of the operating current disclosed in this embodiment can be separately or jointly applied to the LiDAR. When both adjustment methods are applied, the bias voltage can be adjusted first based on the operating temperature during the operation of the LiDAR.

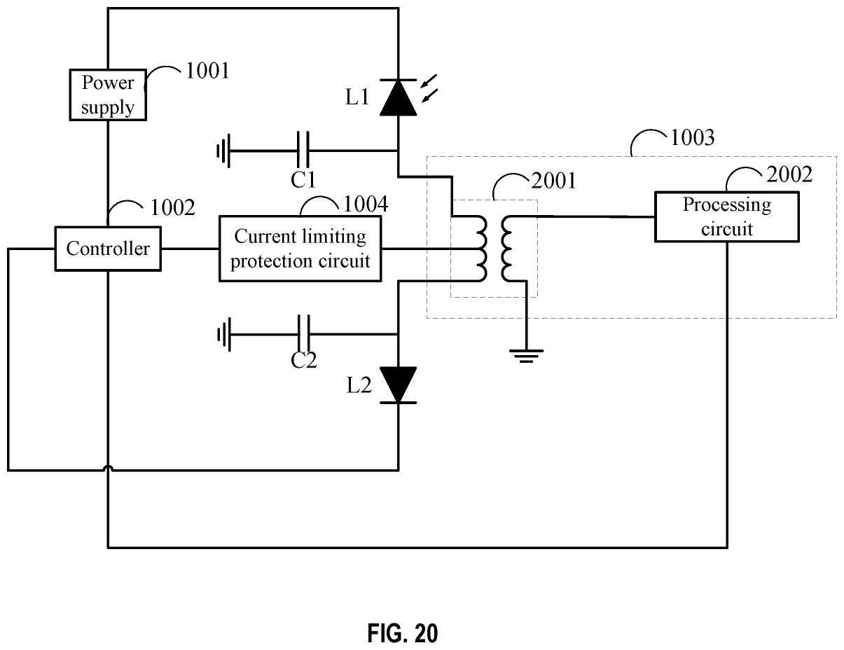

An embodiment of this application provides a sensor protection circuit of a LiDAR. As shown in FIG. 20, the sensor protection circuit may include: a power supply 1001, a first photoelectric sensor L1, a second photoelectric sensor L2, a first capacitor C1, a second capacitor C2, a processing circuit 2002, a transformer 2001, a current limiting protection circuit 1004, and a controller 1002, where the transformer 2001 includes a primary-side coil and a secondary-side coil.

A first end of the controller 1002 is connected to a first end of the power supply 1001, a second end of the power supply 1001 is connected to a cathode of the first photoelectric sensor L1, a third end of the power supply 1001 is connected to a cathode of the second photoelectric sensor L2, an anode of the first photoelectric sensor L1 is connected to a first end of the first capacitor C1, a second end of the first capacitor C1 is grounded, the anode of the first photoelectric sensor L1 is connected to the primary-side coil of the transformer 2001, an anode of the second photoelectric sensor L2 is connected to a first end of the second capacitor C2, a second end of the second capacitor C2 is grounded, the anode of the second photoelectric sensor L2 is connected to the primary-side coil of the transformer 2001, the second end of the controller 1002 is connected to the current limiting protection circuit 1004, the current limiting protection circuit 1004 is connected to the primary-side coil of the transformer 2001, the secondary-side coil of the transformer 2001 is connected to the processing circuit 2002, and the processing circuit 2002 is connected to the third end of the controller 1002.

The second photoelectric sensor L2 may be a single-photon array sensor, and may be considered as an avalanche photodiode used during laser communication, which uses an avalanche multiplication effect of charge carriers to amplify a photoelectric signal to improve detection sensitivity.

In this embodiment of this application, the first photoelectric sensor L1 and the second photoelectric sensor L2 are further provided with a decoupling circuit, and the decoupling circuit includes a first capacitor C1 and a second capacitor C2. A first end of the first capacitor C1 is connected to the anode of the first photoelectric sensor L1, a second end of the first capacitor C1 is grounded (for example, connected to a housing), and a first end of the second capacitor C2 is connected to the anode of the second photoelectric sensor L2. A second end of the second capacitor C2 is grounded (for example, connected to a housing), and the first capacitor C1 and the second capacitor C2 are used as decoupling capacitors for reducing the noise of the power supply and stabilizing the bias voltage.

In this embodiment of this application, the second photoelectric sensor L2 is provided with a light shielding member. The light shielding member is configured to shield the second photoelectric sensor L2 from light, and may include, but is not limited to, a light shielding plate, a light shielding cover, or a light shielding fabric. It can be understood that in the absence of light, when the applied bias voltage is greater than the breakdown voltage, the second photoelectric sensor L2 still outputs a second current signal.

An operating principle of the second photoelectric sensor L2 in this embodiment of this application is described below. A current signal on the first photoelectric sensor L1 that is caused by the laser echo signal is referred to as a photocurrent signal, and a current signal caused by the bias voltage provided by the power supply is referred to as a bias current signal. Therefore, the first current signal output by the first photoelectric sensor L1 may only include the bias current signal at most of the time, and at a moment when the laser echo signal reaches the first photoelectric sensor L1, the first current signal includes the photocurrent signal and bias current signal. In addition, the photocurrent signal is weaker than the bias current signal, and therefore, it is difficult for the processing circuit 2002 and even the controller 1002 to detect the photocurrent signal.

Because the second photoelectric sensor L2 is connected to the first photoelectric sensor L1 in parallel and the same power supply 1001 and controller 1002 provide the same bias voltage, the bias voltage of the second photoelectric sensor L2 is equal to that of the first photoelectric sensor L1. That is, bias current signals of the second photoelectric sensor L2 and the first photoelectric sensor L1 are the same. In addition, because the second photoelectric sensor L2 is shielded from light, the second current signal output by the second photoelectric sensor L2 is the bias current signal at any moment. Therefore, the transformer 2001 receives the first echo signal from the first photoelectric sensor L1 and the second echo signal form the second photoelectric sensor L2, performs differential processing, and removes a current value belonging to the second echo signal from the first echo signal, to obtain the differential current signal. The differential current signal obtained by the processing circuit 2002 includes only a photocurrent part. Therefore, the differential current signal obtained by the processing circuit 2002 is a photocurrent signal when the laser echo signal reaches the first photoelectric sensor L1, and the differential current signal should be 0 outside the moment when the laser echo signal reaches the first photoelectric sensor L1.

The beneficial effects provided by the technical solutions in some embodiments of this application include at least as follows. The processing circuit 2002 and even the controller 1002 can sensitively detect the photocurrent signal. At a moment when it is detected that the differential current signal obtained by the processing circuit 2002 is not 0, this moment is used as the moment when the laser echo signal reaches the first photoelectric sensor L1, thereby improving the sensitivity and accuracy of detecting the laser echo signal and improving the accuracy of ranging.

The transformer 2001 can be considered as a component that receives the first echo signal from the first photoelectric sensor L1 and the second echo signal from the second photoelectric sensor L2, performs differential processing to obtain the differential current signal, and amplifies the voltage value of the differential current signal by using a principle of electromagnetic induction. In some embodiments, a balun transformer is used. The balun transformer, which has functions of balance-to-unbalance transformation and impedance transformation, is an unbalanced transformer used for a twisted pair.

The processing circuit 2002 can be considered as a circuit that collects the differential current signal through the transformer 2001, processes the differential current signal to obtain a differential voltage signal, and transmits the differential voltage signal to the controller 1002.

It should be noted that there are at least two methods for implementing the receiving and outputting circuit 1003. One method is to first perform differential processing and then transimpedance amplification on the first echo signal and the second echo signal on the first photoelectric sensor L1 and the second photoelectric sensor L2, that is, the implementation provided in the foregoing embodiment of this application. The other method is to first perform transimpedance amplification on the first echo signal and the second echo signal, and then perform differential processing on the first echo signal and the second echo signal, that is, a second implementation. Because using the second implementation limits an effective dynamic range of a signal link and increases power consumption and cost, in the present invention, the first implementation is used to implement the receiving and outputting circuit 1003.

The beneficial effects provided by the technical solutions in some embodiments of this application include at least as follows. In this embodiment, a balun transformer with a low insertion loss and high symmetry, that is, a balun transformer with low signal attenuation and good reduction processing performance, can be used to obtain a photocurrent signal range close to the output of a single photosensor. Thermal noise of a matching resistor is increased, which is much lower than a current noise of the transimpedance amplification circuit (such noise exists in all transimpedance amplification processing) and has negligible impact on a signal-to-noise ratio of the photocurrent signal. Only a very small thermal noise is added, and the photocurrent signal is basically not weakened, which has little impact on the signal-to-noise ratio, and the capability of the circuit to amplify the photocurrent signal is barely decreased.

In another embodiment, the implementation of the receiving and outputting circuit 1003 may be as follows. The first echo signal and the second echo signal output by the first photoelectric sensor L1 and the second photoelectric sensor L2 are separately input into a transimpedance amplifier for primary amplification, the amplified first echo signal and second echo signal are output, then the amplified first echo signal and second echo signal are input into a subtractor. A differential voltage signal is output, and then the differential voltage signal is subjected to secondary amplification.

It can be understood that the current limiting protection circuit 1004 is configured to perform amplification processing on the initial voltage signal based on a preset operation rule to obtain a negative bias voltage signal, and load the negative bias voltage signal to the anode of the first photoelectric sensor L1, to reduce a current value of the first photoelectric sensor L1.

For example, an operating process of the sensor protection circuit in this application is as follows. The first photoelectric sensor L1 includes a highly sensitive SiPM (silicon photomultiplier). An avalanche effect occurs when photons are received, a current output by each micro-unit in the first photoelectric sensor L1 suddenly increases, a current value and the number of photons are linearly positively correlated, and a photoelectric amplification capability (namely, Gain) is positively correlated to the bias voltage. At a moment T1, the controller 1002 outputs a drive voltage signal V1 to the current limiting protection circuit 1004, and the current limiting protection circuit 1004 receives and then amplifies the drive voltage signal V1 to obtain a negative bias voltage signal Vm, and loads the negative bias voltage signal Vm onto the anodes of the first photoelectric sensor L1 and the second photoelectric sensor L2. The first photoelectric sensor L1 outputs the first echo signal Ia, and the second photoelectric sensor L2 outputs the second echo signal Ib under action of the bias voltage. The processing circuit 2002 receives a differential current signal Ic through the transformer 2001, where Ic=Ia−Ib, and the processing circuit 2002 converts the differential current signal Ic into a voltage signal and amplifies the differential current signal Ic to obtain a differential voltage signal Vc, and outputs the differential voltage signal Vc to the controller 1002. The controller 1002 receives the differential voltage signal Vc, and compares the differential voltage signal Vc with a voltage threshold V0, and a voltage value Vc of the differential voltage signal is greater than the voltage threshold V0, and the controller 1002 outputs an initial voltage signal V2 to the current limiting protection circuit 1004, where the initial voltage signal V2 is greater than the drive voltage signal V1. The current limiting protection circuit 1004 receives and then amplifies the initial voltage signal V2 to obtain a negative bias voltage signal Vn, and loads the negative bias voltage signal Vn onto the anodes of the first photoelectric sensor L1 and the second photoelectric sensor L2. Because a positive bias voltage signal Vd loaded by the power supply 1001 to the first photoelectric sensor L1 is unchanged, the bias voltage of the first photoelectric sensor L1 decreases, a photoelectric amplification capability decreases (that is, the gain decreases), and a current value of the current Ia of the first photoelectric sensor L1 becomes smaller.

The beneficial effects provided by the technical solutions in some embodiments of this application include at least as follows. The current limiting protection circuit can be used to limit the operating current of the photoelectric sensor, to prevent an excessively large operating current from generating heat inside the photoelectric sensor, which otherwise causes abnormal operation and even damage to the photoelectric sensor, thereby significantly improving the operation reliability of the photoelectric sensor when receiving high reflected energy, and improving the ranging ability of the photoelectric sensor.

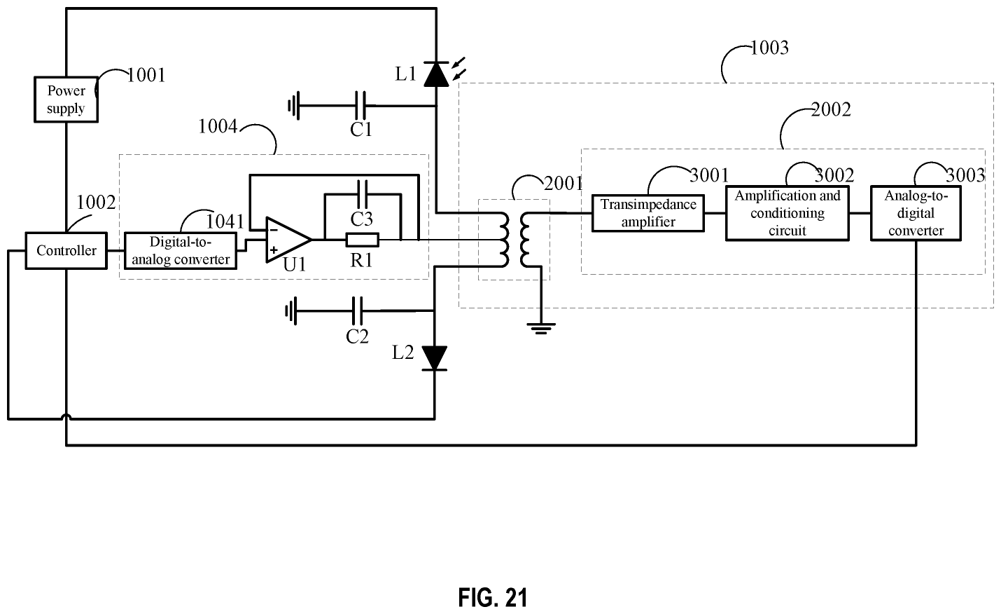

FIG. 21 is a schematic diagram of a connection of another sensor protection circuit according to an embodiment of this application. As shown in FIG. 21, the sensor protection circuit includes: a power supply 1001, a first photoelectric sensor L1, a second photoelectric sensor L2, a first capacitor C1, a second capacitor C2, a processing circuit 2002, a transformer 2001, a current limiting protection circuit 1004, and a controller 1002, where the transformer 2001 includes a primary-side coil and a secondary-side coil.

A first end of the controller 1002 is connected to a first end of the power supply 1001, a second end of the power supply 1001 is connected to a cathode of the first photoelectric sensor L1, a third end of the power supply 1001 is connected to a cathode of the second photoelectric sensor L2, an anode of the first photoelectric sensor L1 is connected to a first end of the first capacitor C1, a second end of the first capacitor C1 is grounded, the anode of the first photoelectric sensor L1 is connected to the primary-side coil of the transformer 2001, an anode of the second photoelectric sensor L2 is connected to a first end of the second capacitor C2, a second end of the second capacitor C2 is grounded, the anode of the second photoelectric sensor L2 is connected to the primary-side coil of the transformer 2001, the second end of the controller 1002 is connected to the current limiting protection circuit 1004, the current limiting protection circuit 1004 is connected to the primary-side coil of the transformer 2001, the secondary-side coil of the transformer 2001 is connected to the processing circuit 2002, and the processing circuit 2002 is connected to the third end of the controller 1002.

The current limiting protection circuit 1004 includes: a digital-to-analog converter 1041, a high-voltage operational amplifier U1, a first resistor R1, and a third capacitor C3.

An inverting input terminal of the high-voltage operational amplifier U1 is connected to a primary-side coil of the transformer 1003, an output end of the high-voltage operational amplifier U1 is connected to a first end of the first resistor R1, and the first end of the first resistor R1 is connected to a first end of the third capacitor C3. The second end of the first resistor R1 is connected to the second end of the third capacitor C3, an input end of the digital-to-analog converter 1041 is connected to the second end of the controller 1002, and an output end of the digital-to-analog converter 1041 is connected to a non-inverting input terminal of the high-voltage operational amplifier U1.

The receiving and outputting circuit 1003 includes: a transformer 2001, a transimpedance amplifier 3001, an amplification and conditioning circuit 3002, and an analog-to-digital converter 3003.

The transimpedance amplifier 3001 is connected to a secondary-side coil of the transformer 2001, the amplification and conditioning circuit 3002 is connected to the transimpedance amplifier 3001, the digital-to-analog converter 3003 is connected to the amplification and conditioning circuit 3002, and a second end of the controller 1002 is connected to the digital-to-analog converter 3003.

The digital-to-analog converter 1041 (DAC) can be considered as a device that converts discrete digital signals into continuous analog signals, and mainly includes a digital register, an analog electronic switch, a bit weight network, a summation operation amplifier, and a reference voltage source (or constant current source). For example, models of the digital-to-analog converter 1041 include but are not limited to DAC7311IDCKR and DAC7311IDCKR.

In this embodiment of this application, the digital-to-analog converter 1041 is configured to receive the initial voltage signal from the controller 1002 and perform digital-to-analog conversion on the initial voltage signal to obtain a converted voltage signal, and output the converted voltage signal to the high-voltage operational amplifier U1.

In another embodiment, the current limiting protection circuit 1004 does not include the digital-to-analog converter 1041, and the second end of the controller 1002 is connected to the non-inverting input terminal of the high-voltage operational amplifier U1. In this embodiment, an initial voltage signal output by the second end of the controller 1002 is an analog electrical signal, and can be directly received by the high-voltage operational amplifier U1.

The high-voltage operational amplifier U1 can be considered as a signal amplifier for outputting with high-voltage amplitude, and is configured to receive a converted voltage signal from the digital-to-analog converter 1041 and then perform amplification processing based on a preset operation rule to obtain a negative bias voltage signal, the first resistor R1 limits a current, and then, the negative bias voltage signal is loaded onto the anode of the first photoelectric sensor L1. For example, a value of the voltage of the converted voltage signal loaded onto the non-inverting input terminal of the high-voltage operational amplifier U1 is 5 V, and a 200V negative bias voltage signal is output and loaded onto the anode of the first photoelectric sensor L1.

In this embodiment of this application, both ends of the first resistor R1 are connected to the third capacitor C3 in parallel. It should be noted that when photons are incident, the incident photons can be effectively absorbed by a large number of single-photon avalanche diodes and excite an avalanche effect, so that the large number of single-photon avalanche diodes can be conducted and output a pulse current. Then, equivalent capacitors Ccell between the two ends of the single-photon avalanche diode need to be charged (due to a structure of the silicon photomultiplier, each single-photon avalanche diode is connected to one equivalent capacitor in parallel), so that the equivalent capacitors of the avalanche diode are fully charged, to recover the normal bias voltage state. Before the equivalent capacitors are fully charged, it is difficult for the silicon photomultiplier to effectively detect incident light and output a current. In this embodiment of this application, the equivalent capacitors refer to the first capacitor C1 and the second capacitor C2. The equivalent capacitors Ccell and a quenching resistor Rq determine a recovery time constant of the micro-unit, and time for recovering 90% of the bias voltage is about 2.3 times the time constant, that is, the recovery time can satisfy: Trecovery=2.3×Rq×Ccell. When the current limiting protection circuit 1004 includes only the first resistor R1, the first resistor R1 and the first capacitor C1 or the second capacitor C2 form an RC circuit. After the bias voltage is greater than the breakdown voltage and the avalanche effect occurs in the first photoelectric sensor L1, the RC circuit slows down a voltage change of the anode end of the first photoelectric sensor L1, and prolongs the recovery time of the first photoelectric sensor L1.

The beneficial effects provided by the technical solutions in some embodiments of this application include at least as follows. Both ends of the first resistor R1 are connected to the third capacitor C3 in parallel, which can store energy when the value of the current output by the first photoelectric sensor L1 changes rapidly, and can provide the charge required for the rapid change of the voltage at the anode end of the first photoelectric sensor L1, thereby shortening the recovery time of the first photoelectric sensor L1.

It can be understood that the transimpedance amplifier 3001 (TIA) converts the input voltage signal into a current signal that satisfies a specific relationship. The converted current is equivalent to an output adjustable constant current source, and an output current should remain stable instead of changing along with loads. In this embodiment of this application, the transimpedance amplifier 3001 performs current-to-voltage conversion on a differential current signal received by the transformer 2001, to obtain a to-be-processed differential voltage signal, and outputs the to-be-processed differential voltage signal to the amplification and conditioning circuit 3002.

It can be understood that the amplification and conditioning circuit 3002 amplifies, buffers, or calibrates the analog signal sent from the sensor, so that the analog signal is suitable to be input into an analog-to-digital converter (ADC) to obtain a digital signal, and therefore, the digital signal is output to the controller, so that the controller completes data collection, a control process, calculation, reading display, and other purposes. In this embodiment of this application, the amplification and conditioning circuit 3002 is configured to perform amplification and conditioning on the to-be-processed differential voltage signal to obtain a differential voltage signal, and output the differential voltage signal to the analog-to-digital converter 3003.

The analog-to-digital converter 3003 (A/D converter) can be considered as an electronic component that converts an analog signal into a digital signal. For example, models of the analog-to-digital converter 3003 include but are not limited to ADS822E and ADS8472IBRGZT. In this embodiment of this application, the analog-to-digital converter 3003 is configured to perform analog-to-digital conversion on the differential voltage signal sent from the amplification and conditioning circuit 3002 to obtain a digital voltage signal, and transmit the digital voltage signal to the controller 1002.

In another embodiment, the receiving and outputting circuit 1003 does not include the analog-to-digital converter 3003, and the third end of the controller 1002 is connected to the amplification and conditioning circuit 3002. In this embodiment, the third end of the controller 1002 can receive an analog electrical signal.

For a description of other units and operating processes thereof in the embodiments of this application, refer to description of FIG. 20.

The beneficial effects provided by the technical solutions in some embodiments of this application include at least as follows. The current limiting protection circuit can be used to limit the operating current of the photoelectric sensor, to prevent an excessively large operating current from generating heat inside the photoelectric sensor, which otherwise causes abnormal operation and even damage to the photoelectric sensor, thereby significantly improving the operation reliability of the photoelectric sensor when receiving high reflected energy, and improving the ranging ability of the photoelectric sensor.

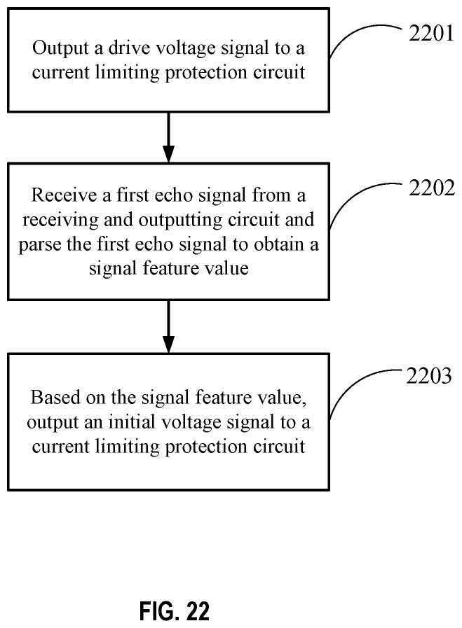

Then, with reference to FIG. 22, another LiDAR adjustment method provided in an exemplary embodiment of this application is introduced. FIG. 22 is a schematic flowchart of a LiDAR adjustment method according to an exemplary embodiment of this application.

As shown in FIG. 22, the LiDAR adjustment method includes the following steps.

S2201. Output a drive voltage signal to a current limiting protection circuit.

The controller outputs a drive voltage signal to the current limiting protection circuit, and the current limiting protection circuit amplifies the initial voltage signal based on a preset operation rule to obtain a negative bias voltage signal, and loads the negative bias voltage signal onto anodes of the first photoelectric sensor and the second photoelectric sensor. The power supply provides a positive bias voltage signal at cathodes of the first photoelectric sensor and the second photoelectric sensor, so that the bias voltage at the first photoelectric sensor and the second photoelectric sensor is greater than the breakdown voltage, and the first photoelectric sensor and the second photoelectric sensor operate normally.

For example, the controller outputs a drive voltage signal V1 to the current limiting protection circuit 1004, and the current limiting protection circuit 1004 receives and then amplifies the drive voltage signal V1 to obtain a negative bias voltage signal Vm, and loads the negative bias voltage signal Vm onto the anodes of the first photoelectric sensor and the second photoelectric sensor. The power supply outputs a positive bias voltage signal Vd and loads the positive bias voltage signal Vd onto the cathodes of the first photoelectric sensor and the second photoelectric sensor, where Vm<Vd. Therefore, a negative bias voltage is formed on the first photoelectric sensor and the second photoelectric sensor, the bias voltage is greater than the breakdown voltage of the first photoelectric sensor, and when receiving photons, the first photoelectric sensor outputs a current value.

S2202. Receive a first echo signal from a receiving and outputting circuit and parse the first echo signal to obtain a signal feature value.

The receiving and outputting circuit can be considered as a circuit that collects a differential current signal from the first photoelectric sensor and the second photoelectric sensor, processes the differential current signal to obtain a differential voltage signal, and transmits the differential voltage signal to the controller.

In an embodiment of this application, the implementation of the voltage compensation circuit may be as follows. The first echo signal and the second echo signal output by the first photoelectric sensor and the second photoelectric sensor are respectively input to both ends on a balanced side of the balun transformer, the differential current signal obtained through differential processing is then coupled to the primary side through the transformer, and then the differential current signal is input to the transimpedance amplifier for transimpedance amplification to obtain the differential voltage signal.

For example, the first photoelectric sensor outputs the first echo signal Ia, and the second photoelectric sensor outputs the second echo signal Ib under action of the bias voltage. The voltage compensation circuit receives a differential current signal Ic through the transformer, where Ic=Ia−Ib. The voltage compensation circuit converts the differential current signal Ic into a differential voltage signal and amplifies the differential voltage signal to obtain a differential voltage signal Vc, and outputs the differential voltage signal Vc to the controller. The controller receives the differential voltage signal Vc, parses the differential voltage signal Vc to obtain a voltage value of 50 V, and then uses the voltage value as the signal feature value of the differential voltage Vc.

S2203. Based on the signal feature value, output an initial voltage signal to a current limiting protection circuit.

For example, the controller receives the differential voltage signal Vc, and compares the differential voltage signal Vc with a voltage threshold V0, where the differential voltage signal Vc is greater than the voltage threshold V0. The controller outputs an initial voltage signal V2 to the current limiting protection circuit, where the initial voltage signal V2 is greater than the drive voltage value V1. The current limiting protection circuit receives and then amplifies the initial voltage signal V2 to obtain a negative bias voltage signal Vn, and loads the negative bias voltage signal Vn onto the anodes of the first photoelectric sensor and the second photoelectric sensor. Because a negative bias voltage signal Vd loaded by the power supply onto the first photoelectric sensor is unchanged, the bias voltage of the first photoelectric sensor decreases, a photoelectric amplification capability decreases (that is, the gain decreases), and a current value of the first echo signal Ia of the first photoelectric sensor becomes smaller.

In an embodiment, a method used for the controller to output the initial voltage signal to the current limiting protection circuit includes: obtaining a voltage value based on the differential voltage signal, where the voltage value is used as a signal feature value; calculating offset between the voltage value and a voltage threshold; based on the offset and a PID calculation model, obtaining a voltage value of the initial voltage signal; and outputting the initial voltage signal to the current limiting protection circuit.

The PID calculation model is a calculation model that calculates an input value based on a PID control theory to obtain an output value. The PID control theory can be considered as a linear control theory of forming control offset based on a given value and an actual output value, and forming a control level by performing linear combination on the offset based on proportion, integral, and differential to control a controlled object.

For example, the controller receives the differential voltage signal Vc of 50 V, the voltage threshold V0 is 30 V, and a calculation formula of offset e between the differential voltage signal Vc and the voltage threshold V0 is as follows:

e(t)=Vc(t)−V0(t)

Linear combination is performed on the offset e based on proportion (P), integral (I), and differential (D) to form a basic formula of the PID calculation model. For a control rule, refer to the following formula:

G(t)=Kₚe(t)+Kᵢ∫₀ⁱe(t)+K_{d}de(t)/dt

where Kp is a proportional coefficient, Ki is an integral constant, and Kd is a differential constant.

Based on the foregoing rule, the basic formula of the PID calculation model is formed, and the initial voltage signal V2 is obtained as 60 V. Main parameters in the PID calculation model are determined in the following methods: a tuning method based on object parameter identification in a controlled process, where a parameter model of an object needs to be first identified in the method, and then tuning is performed in a theoretical calculation tuning method such as a pole placement tuning method or a cancellation principle method; a tuning method based on extraction of an output response feature parameter of an object, such as Ziegler-Nichols parameter tuning method (also referred to as a critical proportioning method); a parameter optimization method; an expert system method based on pattern recognition; an online tuning method based on a controller parameter for controlling behavior of the controller, and the like.

The foregoing description is only about an exemplary method for the controller to obtain the voltage value of the initial voltage signal based on the voltage value of the differential voltage signal, and a calculation method of the controller is not limited in this application.

The beneficial effects provided by the technical solutions in some embodiments of this application include at least as follows. The current limiting protection circuit can be used to limit the operating current of the photoelectric sensor, to prevent an excessively large operating current from generating heat inside the photoelectric sensor, which otherwise causes abnormal operation and even damage to the photoelectric sensor, thereby significantly improving the operation reliability of the photoelectric sensor when receiving high reflected energy, and improving the ranging ability of the photoelectric sensor.

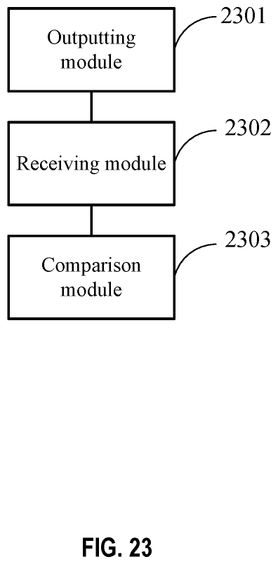

FIG. 23 shows a current limiting protection apparatus of a LiDAR according to an embodiment of this application. The current limiting protection apparatus can be implemented as all or a part of the apparatus through software, hardware, or a combination thereof. The current limiting protection apparatus includes an outputting module 2301, a receiving module 2302, and a comparison module 2303.

The outputting module 2301 is configured to output a drive voltage signal to a current limiting protection circuit.

The receiving module 2302 is configured to receive a first echo signal from a receiving and outputting circuit and parse the first echo signal to obtain a signal feature value, where the first echo signal is obtained by the receiving and outputting circuit by using the first photoelectric sensor.

The comparison module 2303 is configured to: based on the signal feature value, output an initial voltage signal to the current limiting protection circuit. The initial voltage signal is used to instruct the current limiting protection circuit to output a negative bias voltage signal and load the negative bias voltage signal onto an anode of the first photoelectric sensor, so as to reduce a current value of the first photoelectric sensor.

An embodiment of this application also provides a computer storage medium. The computer storage medium may store a plurality of instructions. The instructions are capable of being loaded by a processor to perform the current limiting protection method shown in FIG. 22. For a specific execution process, refer to the specific description of the embodiments shown in FIG. 22. Details are not described herein again.

This application further provides a computer program product. The computer program product stores at least one instruction. The at least one instruction is capable of being loaded by the processor to perform the current limiting protection method shown in FIG. 22. For a specific execution process, refer to the specific description of the embodiments shown in FIG. 22. Details are not described herein again.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or the functions according to the embodiments of this application are all or partially generated. The computer may be a general-purpose computer, a special-purpose computer, a computer network, or other programmable apparatuses. The computer instruction may be stored in a computer readable storage medium, or may be transmitted by using the computer readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, Digital Versatile Disc (DVD), a semiconductor medium (for example, a solid state disk (SSD)), or the like.

A person of ordinary skill in the art may understand that all or some of the processes of the methods in the embodiments may be implemented by a computer program instructing relevant hardware. The program may be stored in a computer readable storage medium. When the program is executed, the processes of the methods in the embodiments are performed. In addition, the foregoing storage medium includes various media that can store program code, such as a ROM, a RAM, a magnetic disk, or an optical disc. In absence of conflicts, the embodiments and features in the embodiments may be randomly combined.

The foregoing described embodiments are only exemplary embodiments of this application, and are not intended to limit the scope of this application. Without departing from design spirit of this application, various transformations and improvements made by a person of ordinary skill in the art to the technical solutions of this application shall fall within the protection scope defined in claims of this application.

What is claimed is:

1. A LiDAR adjustment method, applied to a LiDAR, wherein the LiDAR comprises a photoelectric sensor and the method comprises:
obtaining an operating temperature of the photoelectric sensor;
determining a target bias voltage based on the operating temperature, wherein the target bias voltage is a difference between voltages applied to a cathode and an anode of the photoelectric sensor; and
based on the target bias voltage, adjusting the voltages applied to at least one of the anode and the cathode of the photoelectric sensor.

2. The LiDAR adjustment method according to claim 1, wherein the determining a target bias voltage based on the operating temperature comprises:
determining the target bias voltage corresponding to the operating temperature based on a preset mapping relationship, wherein the preset mapping relationship comprises a plurality of temperatures and bias voltages respectively corresponding to different temperatures.

3. The LiDAR adjustment method according to claim 2, wherein the LiDAR further comprises a power supply, and based on the target bias voltage, adjusting the voltages applied to at least one of the anode and the cathode of the photoelectric sensor comprises:
based on the target bias voltage, determining a duty ratio of a modulation signal applied to the power supply; and
based on the modulation signal with the duty ratio, controlling the power supply to output a target voltage to at least one of the anode and the cathode of the photoelectric sensor.

4. The LiDAR adjustment method according to claim 3, wherein the power supply comprises a first end and a second end, and based on the target bias voltage, the determining a duty ratio of a modulation signal applied to the power supply and based on the modulation signal with the duty ratio, controlling the power supply to output a target voltage to at least one of the anode and the cathode of the photoelectric sensor comprises:
determining a value of the voltage applied to the cathode of the photoelectric sensor;
based on the target bias voltage and the value of the voltage applied to the cathode of the photoelectric sensor, determining a value of the voltage applied to the anode of the photoelectric sensor;
determining the duty ratio of the modulation signal based on the value of the voltage of the anode of the photoelectric sensor; and
based on the modulation signal with the duty ratio, controlling the first end to output the target voltage to the anode of the photoelectric sensor;
or
determining a value of the voltage applied to the anode of the photoelectric sensor;
based on the target bias voltage and the value of the voltage applied to the anode of the photoelectric sensor, determining a value of the voltage applied to the cathode of the photoelectric sensor;
determining the duty ratio of the modulation signal based on the value of the voltage of the cathode of the photoelectric sensor; and
based on the modulation signal with the duty ratio, controlling the second end to output the target voltage to the cathode of the photoelectric sensor.

5. The LiDAR adjustment method according to claim 1, wherein the LiDAR further comprises a high-voltage operational amplifier, and
the determining a target bias voltage based on the operating temperature comprises:
when the operating temperature of the photoelectric sensor satisfies a preset condition, determining that the target bias voltage is a preset bias voltage, wherein
the based on the target bias voltage, adjusting the voltages applied to at least one of the anode and the cathode of the photoelectric sensor comprises:
based on the preset bias voltage, by using the high-voltage operational amplifier, switching the first voltage applied to the cathode of the photoelectric sensor to a second voltage, wherein the second voltage is less than the first voltage.

6. The LiDAR adjustment method according to claim 5, wherein the LiDAR further comprises a power supply, the power supply comprises a first end and a second end, and the determining a target bias voltage based on the operating temperature comprises:
when the operating temperature of the photoelectric sensor does not satisfy a preset condition, determining the target bias voltage corresponding to the operating temperature based on a preset mapping relationship, wherein the preset mapping relationship comprises a plurality of temperatures and bias voltages respectively corresponding to different temperatures, wherein
based on the target bias voltage, adjusting the voltages applied to at least one of the anode and the cathode of the photoelectric sensor comprises:
determining a value of the voltage applied to the cathode of the photoelectric sensor;
based on the target bias voltage and the value of the voltage applied to the cathode of the photoelectric sensor, determining a value of the voltage applied to the anode of the photoelectric sensor;
determining the duty ratio of the modulation signal based on the value of the voltage of the anode of the photoelectric sensor; and
based on the modulation signal with the duty ratio, controlling the first end to output the target voltage to the anode of the photoelectric sensor;
or
determining a value of the voltage applied to the anode of the photoelectric sensor;
based on the target bias voltage and the value of the voltage applied to the anode of the photoelectric sensor, determining a value of the voltage applied to the cathode of the photoelectric sensor;
determining the duty ratio of the modulation signal based on the value of the voltage of the cathode of the photoelectric sensor; and
based on the modulation signal with the duty ratio, controlling the second end to output the target voltage to the cathode of the photoelectric sensor.

7. A LiDAR adjustment circuit, wherein the LiDAR adjustment circuit comprises: a control sub-circuit, a detection sub-circuit, and a photoelectric sensor, wherein
the detection sub-circuit is connected to the photoelectric sensor and configured to detect an operating temperature of the photoelectric sensor;
the control sub-circuit is connected to the detection sub-circuit and the photoelectric sensor;
the photoelectric sensor is configured to receive an echo signal; and
the control sub-circuit is configured to control the detection sub-circuit to detect the operating temperature of the photoelectric sensor, and is further configured to: determine a target bias voltage based on the operating temperature and based on the target bias voltage, adjust a value of a voltage applied to at least one of an anode and a cathode of the photoelectric sensor, and the target bias voltage is a difference between the voltages applied to the anode and the cathode of the photoelectric sensor.

8. The LiDAR adjustment circuit according to claim 7, wherein the control sub-circuit is configured to: determine the target bias voltage corresponding to the operating temperature based on a preset mapping relationship, and based on the target bias voltage, adjust the voltage applied to at least one of the anode and the cathode of the photoelectric sensor, and the preset mapping relationship comprises a plurality of temperatures and bias voltages respectively corresponding to different temperatures.

9. The LiDAR adjustment circuit according to claim 7, wherein the control sub-circuit comprises a power supply and a controller, and the power supply comprises a first end and a second end, wherein
the first end is connected to the cathode of the photoelectric sensor, and is configured to provide a voltage for the cathode of the photoelectric sensor;
the second end is connected to the anode of the photoelectric sensor, and is configured to provide a voltage for the anode of the photoelectric sensor; and
the controller is configured to: based on the target bias voltage, determine a duty ratio of a modulation signal applied to at least one of the anode and the cathode of the photoelectric sensor, and output the modulation signal to at least one of the first end and the second end based on the duty ratio, to provide the voltage for at least one of the cathode and the anode of the photoelectric sensor.

10. The LiDAR adjustment circuit according to claim 9, wherein the controller is configured to determine the value of the voltage applied to the cathode of the photoelectric sensor; and
the controller is also configured to: based on the target bias voltage and the value of the voltage applied to the cathode of the photoelectric sensor, determine a duty ratio of a modulation signal applied to the second end, and output the modulation signal to the second end based on the duty ratio, to provide a voltage for the anode of the photoelectric sensor;
or
the controller is configured to determine a value of the voltage applied to the anode of the photoelectric sensor; and
the controller is also configured to: based on the target bias voltage and the value of the voltage applied to the anode of the photoelectric sensor, determine a duty ratio of a modulation signal applied to the first end, and output the modulation signal to the first end based on the duty ratio, to provide a voltage for the cathode of the photoelectric sensor.

11. The LiDAR adjustment circuit according to claim 9, wherein the LiDAR adjustment circuit further comprises a voltage step-down sub-circuit, wherein
an end of the voltage step-down sub-circuit is connected to the first end;
another end of the voltage step-down sub-circuit is connected to the photoelectric sensor; and
the voltage step-down sub-circuit is configured to lower the voltage of the cathode of the photoelectric sensor.

12. The LiDAR adjustment circuit according to claim 7, wherein the control sub-circuit comprises a power supply, a controller, and a high-voltage operational amplifier, wherein
the power supply is configured to supply energy to the photoelectric sensor and apply a bias voltage to both ends of the photoelectric sensor;
the controller is configured to: when the operating temperature of the photoelectric sensor satisfies a preset condition, determine that the target bias voltage is a preset bias voltage; and
the controller is also configured to: based on the preset bias voltage, by using the high-voltage operational amplifier, switch a first voltage applied to the cathode of the photoelectric sensor to a second voltage, wherein the second voltage is less than the first voltage.

13. The LiDAR adjustment circuit according to claim 12, wherein the power supply comprises a first end and a second end;
the controller is also configured to: when the operating temperature of the photoelectric sensor does not satisfy a preset condition, determine the target bias voltage corresponding to the operating temperature based on a preset mapping relationship, wherein the preset mapping relationship comprises a plurality of temperatures and bias voltages respectively corresponding to different temperatures; and
the controller is also configured to:
determine a value of the voltage applied to the cathode of the photoelectric sensor;
based on the target bias voltage and the value of the voltage applied to the cathode of the photoelectric sensor, determine a value of the voltage applied to the anode of the photoelectric sensor;
determine a duty ratio of a modulation signal based on the value of the voltage of the anode of the photoelectric sensor; and
based on the modulation signal with the duty ratio, control the first end to output the target voltage to the anode of the photoelectric sensor;
or
determine a value of the voltage applied to the anode of the photoelectric sensor;
based on the target bias voltage and the value of the voltage applied to the anode of the photoelectric sensor, determine a value of the voltage applied to the cathode of the photoelectric sensor;
determine a duty ratio of a modulation signal based on the value of the voltage of the cathode of the photoelectric sensor; and
based on the modulation signal with the duty ratio, control the second end to output the target voltage to the cathode of the photoelectric sensor.

14. A LiDAR, comprising: a photoelectric sensor, a processor, and a memory, wherein
the processor is connected to the photoelectric sensor and the memory;
the photoelectric sensor is configured to receive an echo signal;
the memory is configured to store an executable program code; and
the processor reads the executable program code stored in the memory to run a program corresponding to the executable program code, to perform operations comprising:
obtaining an operating temperature of the photoelectric sensor;
determining a target bias voltage based on the operating temperature, wherein the target bias voltage is a difference between voltages applied to a cathode and an anode of the photoelectric sensor; and
based on the target bias voltage, adjusting the voltages applied to at least one of the anode and the cathode of the photoelectric sensor.
